(19) United States
(12) Patent Application Publication
(10) Pub. No.: US 2018/0160377 A1
(43) Pub. Date: Jun. 7, 2018

(54) TECHNIQUES FOR MITIGATING RADIO FREQUENCY EXPOSURE OF OBJECTS PROXIMATE TO A WIRELESS DEVICE

(71) Applicant: QUALCOMM Incorporated, San Diego, CA (US)

(72) Inventors: Victor Abramsky, Edison, NJ (US); Andrzej Partyka, Bedminster, NJ (US)

(21) Appl. No.: 15/830,739

(22) Filed: Dec. 4, 2017

Related U.S. Application Data
(60) Provisional application No. 62/431,309, filed on Dec. 7, 2016.

(51) Int. Cl. H04W 52/28; H04B 7/06

(52) U.S. Cl. CPC H04W 52/283; H04B 7/0617

(57) ABSTRACT

Techniques are described for wireless communication at a wireless device, such as a base station, a user equipment, a customer premises equipment (CPE), etc. Some such wireless devices may communicate using beamformed transmissions, which may focus transmission energy in a particular direction. In accordance with the described techniques, a wireless device (e.g., which may or may not use beamforming) may detect an object within an energy mitigation area proximate to the wireless device. The wireless device may determine an allowable energy density at the object based at least in part on the object detection. The wireless device may adjust at least one radio frequency (RF) transmission parameter based at least in part on the allowable energy density at the object.

### CROSS REFERENCES

The present Application for Patent claims priority to U.S. Provisional Patent Application No. 62/431,309 by Abramsky, et al., entitled “Techniques For Mitigating Radio Frequency Exposure of Objects Proximate to a Wireless Device,” filed Dec. 7, 2016, assigned to the assignee hereof.

### BACKGROUND

### Field of the Disclosure

The present disclosure, for example, relates to wireless communication systems, and more particularly to techniques for mitigating radio frequency (RF) exposure of objects proximate to a wireless device.

### Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

A wireless multiple-access communication system may include a number of network access devices, each simultaneously supporting communication for multiple communication devices, otherwise known as user equipment (UEs). In a Long-Term Evolution (LTE) or LTE-Advanced (LTE-A) network, a network access device may take the form of a base station, with a set of one or more base stations defining an eNodeB (eNB). In a next generation, 5G, millimeter wave (mmW), or new radio (NR) network, a network access device may take the form of a smart radio head (RH) or access node controller (ANC), with a set of smart RHs in communication with an ANC defining a gNodeB (gNB). In a wireless local area network (WLAN), a network access device may take the form of a WLAN access point. A network access device may communicate with a UE on downlink channels (e.g., for transmissions from the network access device to the UE) and uplink channels (e.g., for transmissions from the UE to the network access device).

Some wireless devices, such as customer premises equipment (CPE), UEs, network access devices, etc., may communicate with other wireless devices using an antenna array. For example, a CPE may act as a demarcation point between a customer's premises and a network and in some examples may be a transportable device. In some examples, a plurality (or all) of the antennas in an antenna array may be used to transmit a beamformed transmission. A beamformed transmission may include a plurality of transmissions from different antennas, which transmissions are phase-shifted and/or power-controlled in accordance with a precoder to produce a directional transmission. The beamformed transmission may have a higher radio frequency (RF) transmit power in a desired direction (e.g., a higher RF transmit power than a non-beamformed or non-directional transmission).

### SUMMARY

Because a beamformed transmission may have a higher RF transmit power in a given direction, there may be a higher probability that the energy density of the beamformed transmission exceeds a desired or allowed energy density—especially near the wireless device that transmits the beamformed transmission. The present disclosure describes techniques for mitigating RF exposure of objects proximate to a wireless device that transmits a beamformed transmission (or another type of transmission having an energy density exceeding a desired or maximum energy density).

In one example, a method for wireless communication at a wireless device is described. The method may include detecting an object within an energy mitigation area proximate to the wireless device, determining an allowable energy density at the object based at least in part on the object detection, and adjusting at least one RF transmission parameter of the wireless device based at least in part on the allowable energy density at the object.

In some examples, the method may include notifying a user of the wireless device upon detecting the object within the energy mitigation area. In some examples, the method may include receiving a reset indication from the user, determining a distance between the wireless device and the object after detecting the object or receiving the reset indication, and resetting the at least one RF transmission parameter of the wireless device based on the determined distance. In some examples, the method may include detecting, after resetting the at least one RF transmission parameter of the wireless device, a trigger condition comprising a movement of the wireless device or an enablement of RF transmission parameter adjustment at the wireless device, and enabling adjustment of the at least one RF transmission parameter of the wireless device based at least in part on the trigger condition.

In some examples of the method, detecting the object within the energy mitigation area may include detecting that the object has at least one characteristic of a living organism. In some examples, detecting that the object has at least one characteristic of a living organism may include detecting at least one of a movement of the object, a capacitance of the object, a thermal energy of the object, or a combination thereof. In some examples, the movement of the object may be detected based at least in part on infrared motion sensing, image processing, thermal imaging, or a combination thereof. In some examples, the method may include detecting a movement of the object to a second location outside the energy mitigation area and resetting the at least one RF transmission parameter of the wireless device.

In some examples of the method, detecting the object within the energy mitigation area may include determining a distance between the wireless device and the object. In these examples, the allowable energy density at the object may be further determined based at least in part on the determined distance between the wireless device and the object. In some examples, the allowable energy density may be further determined based at least in part on a directionality of RF energy emitted by the wireless device. In some examples, adjusting the at least one RF transmission parameter may include altering a RF transmission duty cycle of the wireless device, altering a RF transmit power of the wireless device, altering a beamforming parameter of the wireless device, or a combination thereof. In some examples, adjusting the RF transmit power may include reducing the RF transmit power or ceasing RF transmissions.

In some examples of the method, the at least one RF transmission parameter of the wireless device may be further adjusted based at least in part on a quality of a RF communication link between the wireless device and a second wireless device. In some examples, the method may include determining a set of one or more RF transmission parameters for each of a plurality of antennas, antenna subarrays, RF transmission beams, or combinations thereof. In these examples, adjusting the at least one RF transmission parameter of the wireless device may include selecting one of the antennas, antenna subarrays, RF transmission beams, or combinations thereof. In some examples, the method may include determining at least one beamforming parameter to communicate with a second wireless device, determining a maximum value of the at least one RF transmission parameter to communicate with the second wireless device, and identifying the energy mitigation area based at least in part on the at least one beamforming parameter and the maximum value of the at least one RF transmission parameter. In some examples, the method may include detecting a movement of the wireless device, and ceasing RF transmissions of the wireless device while the wireless device is moving.

In one example, an apparatus for wireless communication is described. The apparatus may include means for detecting an object within an energy mitigation area proximate to the apparatus, means for determining an allowable energy density at the object based at least in part on the object detection, and means for adjusting at least one RF transmission parameter of the apparatus based at least in part on the allowable energy density at the object.

In some examples, the apparatus may include means for notifying a user of the apparatus upon detecting the object within the energy mitigation area. In some examples, the apparatus may include means for receiving a reset indication from the user, means for determining a distance between the apparatus and the object after detecting the object or receiving the reset indication, and means for resetting the at least one RF transmission parameter of the apparatus based on the determined distance. In some examples, the apparatus may include means for detecting, after resetting the at least one RF transmission parameter of the apparatus based on the determined distance, a trigger condition including at a movement of the apparatus, an enablement of RF transmission parameter adjustment at the apparatus, or a combination thereof, and means for enabling adjustment of the at least one RF transmission parameter of the apparatus based on the trigger condition.

In some examples of the apparatus, the means for detecting the object within the energy mitigation area may include means for detecting that the object has at least one characteristic of a living organism. In some examples, the means for detecting that the object has at least one characteristic of a living organism may include means for detecting at least one of a movement of the object, a capacitance of the object, a thermal energy of the object, or a combination thereof In some examples, the movement of the object may be detected based at least in part on infrared motion sensing, image processing, thermal imaging, or a combination thereof. In some examples, the apparatus may include means for detecting a movement of the object to a second location outside the energy mitigation area, and means for resetting the at least one RF transmission parameter of the apparatus, based at least in part on the allowable energy density at the object, after detecting the movement of the object to the second location outside the energy mitigation area.

In some examples of the apparatus, the means for detecting the object within the energy mitigation area may include means for determining a distance between the apparatus and the object. In these examples, the allowable energy density at the object may be further determined based at least in part on the determined distance between the apparatus and the object. In some examples, the allowable energy density may be further determined based at least in part on a directionality of RF energy emitted by the apparatus. In some examples, the means for adjusting the at least one RF transmission parameter may include means for altering a RF transmission duty cycle of the apparatus, altering a RF transmit power of the apparatus, altering a beamforming parameter of the apparatus, or a combination thereof. In some examples, the means for adjusting the RF transmit power may include means for reducing the RF transmit power or ceasing RF transmissions.

In some examples of the apparatus, the at least one RF transmission parameter of the apparatus may be further adjusted based at least in part on a quality of a RF communication link between the apparatus and a second apparatus. In some examples, the apparatus may include means for determining a set of one or more RF transmission parameters for each of a plurality of antennas, antenna subarrays, RF transmission beams, or combinations thereof. In these examples, the means for adjusting the at least one RF transmission parameter of the apparatus may include means for selecting one of the antennas, antenna subarrays, RF transmission beams, or combinations thereof. In some examples, the apparatus may include means for determining at least one beamforming parameter to communicate with a second apparatus, means for determining a maximum value of the at least one RF transmission parameter to communicate with the second apparatus, and means for identifying the energy mitigation area based at least in part on the at least one beamforming parameter and the maximum value of the at least one RF transmission parameter. In some examples, the apparatus may include means for detecting a movement of the apparatus, and means for ceasing RF transmissions of the apparatus while the apparatus is moving.

In one example, another apparatus for wireless communication is described. The apparatus may include a processor, memory in electronic communication with the processor, and instructions stored in the memory. The instructions may be executable by the processor to detect an object within an energy mitigation area proximate to the apparatus, to determine an allowable energy density at the object based at least in part on the object detection, and to adjust at least one RF transmission parameter of the apparatus based at least in part on the allowable energy density at the object.

In some examples of the apparatus, the instructions may be executable by the processor to notify a user of the apparatus upon detecting the object within the energy mitigation area. In some examples, the instructions may be executable by the processor to receive a reset indication from the user, to determine a distance between the apparatus and the object after detecting the object or receiving the reset indication, and to reset the at least one RF transmission parameter of the apparatus, based on the determined distance, after receiving the reset indication from the user. In some examples, the instructions may be executable by the processor to detect, after resetting the at least one RF transmission parameter of the apparatus based on the determined distance, a trigger condition including a movement of the apparatus, an enablement of RF transmission parameter adjustment at the apparatus, or a combination thereof, and to enable adjustment of the at least one RF transmission parameter of the apparatus, based on the trigger condition.

In some examples of the apparatus, the instructions executable by the processor to detect the object within the energy mitigation area may include instructions executable by the processor to detect that the object has at least one characteristic of a living organism. In some examples, the instructions executable by the processor to detect that the object has at least one characteristic of a living organism may include instructions executable by the processor to detect a movement of the object, a capacitance of the object, a thermal energy of the object, or a combination thereof. In some examples, the movement of the object may be detected based at least in part on infrared motion sensing, image processing, thermal imaging, or a combination thereof. In some examples, the instructions may be executable by the processor to detect a movement of the object to a second location outside the energy mitigation area, and to reset the at least one RF transmission parameter of the apparatus, based at least in part on the allowable energy density at the object, after detecting the movement of the object to the second location outside the energy mitigation area.

In some examples of the apparatus, the instructions executable by the processor to detect the object within the energy mitigation area may include instructions executable by the processor to determine a distance between the apparatus and the object. In these examples, the allowable energy density at the object may be further determined based at least in part on the determined distance between the apparatus and the object. In some examples, the instructions executable by the processor to determine the allowable energy density may further determine the allowable energy density based at least in part on a directionality of RF energy emitted by the apparatus. In some examples, the instructions executable by the processor to adjust the at least one RF transmission parameter may include instructions executable by the processor to alter a RF transmission duty cycle of the apparatus, alter a RF transmit power of the apparatus, or a combination thereof. In some examples, the instructions executable by the processor to adjust the RF transmit power may include instructions executable by the processor to reduce the RF transmit power or cease RF transmissions.

In some examples of the apparatus, the at least one RF transmission parameter of the apparatus may be further adjusted based at least in part on a quality of a RF communication link between the apparatus and a second apparatus. In some examples, the instructions may be executable by the processor to determine a set of one or more RF transmission parameters for each of a plurality of antennas, antenna subarrays, RF transmission beams, or combinations thereof. In these latter examples, the instructions executable by the processor to adjust the at least one RF transmission parameter of the apparatus may include instructions executable by the processor to select one of the antennas, antenna subarrays, RF transmission beams, or combinations thereof. In some examples, the instructions may be executable by the processor to determine at least one beamforming parameter to communicate with a second apparatus, to determine a maximum value of the at least one RF transmission parameter to communicate with the second apparatus, and to determine the energy mitigation area based at least in part on the at least one beamforming parameter and the maximum value of the at least one RF transmission parameter. In some examples, the instructions may be executable by the processor to detect a movement of the apparatus, and to cease RF transmissions of the apparatus while the apparatus is moving.

In one example, a non-transitory computer-readable medium storing code for wireless communication at a wireless device is described. The code may include instructions executable to detect an object within an energy mitigation area proximate to the wireless device, determine an allowable energy density at the object based at least in part on the object detection, and adjust at least one RF transmission parameter of the wireless device based at least in part on the allowable energy density at the object.

In some examples of the non-transitory computer-readable medium, the code may be executable to notify a user of the wireless device upon detecting the object within the energy mitigation area. In some examples, the code may be executable to receive a reset indication from the user, to determine a distance between the wireless device and the object after detecting the object or receiving the reset indication, and to reset the at least one RF transmission parameter of the wireless device, based on the determined distance.

In some examples of the non-transitory computer-readable medium, the code executable to detect the object within the energy mitigation area may include code executable to detect that the object has at least one characteristic of a living organism. In some examples, the code executable to detect that the object has at least one characteristic of a living organism may include code executable to detect a movement of the object, a capacitance of the object, a thermal energy of the object, or a combination thereof.

In some examples of the non-transitory computer-readable medium, the code executable to detect the object within the energy mitigation area may include code executable to determine a distance between the wireless device and the object. In these examples, the allowable energy density at the object may be further determined based at least in part on the determined distance between the wireless device and the object. In some examples, the code executable to adjust the at least one RF transmission parameter may include code executable to alter a RF transmission duty cycle of the wireless device, alter a RF transmit power of the wireless device, or a combination thereof.

The foregoing has outlined rather broadly the techniques and technical advantages of examples according to the disclosure in order that the detailed description that follows may be better understood. Additional techniques and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or functions may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows an example of a wireless communication system, in accordance with one or more aspects of the disclosure;

FIG. 2 shows a CPE that may provide radio frequency exposure mitigation for objects proximate to the CPE, in accordance with various aspects of the present disclosure;

FIG. 3 shows a block diagram of an apparatus including an antenna array and at least one sensor, in accordance with various aspects of the present disclosure;

FIG. 4 shows a block diagram of an apparatus for use in wireless communication, in accordance with one or more aspects of the present disclosure;

FIG. 5 shows a block diagram of a wireless communication manager for use in wireless communication, in accordance with one or more aspects of the present disclosure;

FIG. 6 shows a block diagram of a CPE for use in wireless communication, in accordance with one or more aspects of the present disclosure;

FIG. 7 shows a block diagram of a UE for use in wireless communication, in accordance with one or more aspects of the present disclosure; and

FIGS. 8 through 12 contain flow charts illustrating example methods for wireless communication at a wireless device (e.g., a CPE, UE, or network access device), in accordance with one or more aspects of the present disclosure.

### DETAILED DESCRIPTION

When the transmissions of a wireless device may exceed a desired or maximum energy density, RF exposure mitigation may be used to ensure that objects proximate to the wireless device (e.g., objects within an energy mitigation area) are not exposed to excessive energy. The present disclosure describes various techniques for providing RF exposure mitigation. Some of the techniques include detecting an object within an energy mitigation area proximate to a wireless device, determining an allowable energy density at the object based at least in part on the object detection, and adjusting at least one RF transmission parameter of the wireless device based at least in part on the allowable energy density at the object. The adjusted RF transmission parameter may include, for example, a RF transmission duty cycle of the wireless device, a RF transmit power of the wireless device, or a combination thereof. In some examples, a user of the wireless device may be notified of an object detection and given an option to override the RF transmission parameter adjustment(s) that the wireless device has made. In some examples, detecting the object may include detecting whether the object has at least one characteristic of a living organism (e.g., a person, an animal, or a bird), and RF exposure mitigation may be invoked just for objects that are presumed to be living organisms.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various operations may be added, omitted, or combined. Also, features described with respect to some examples may be combined in some other examples.

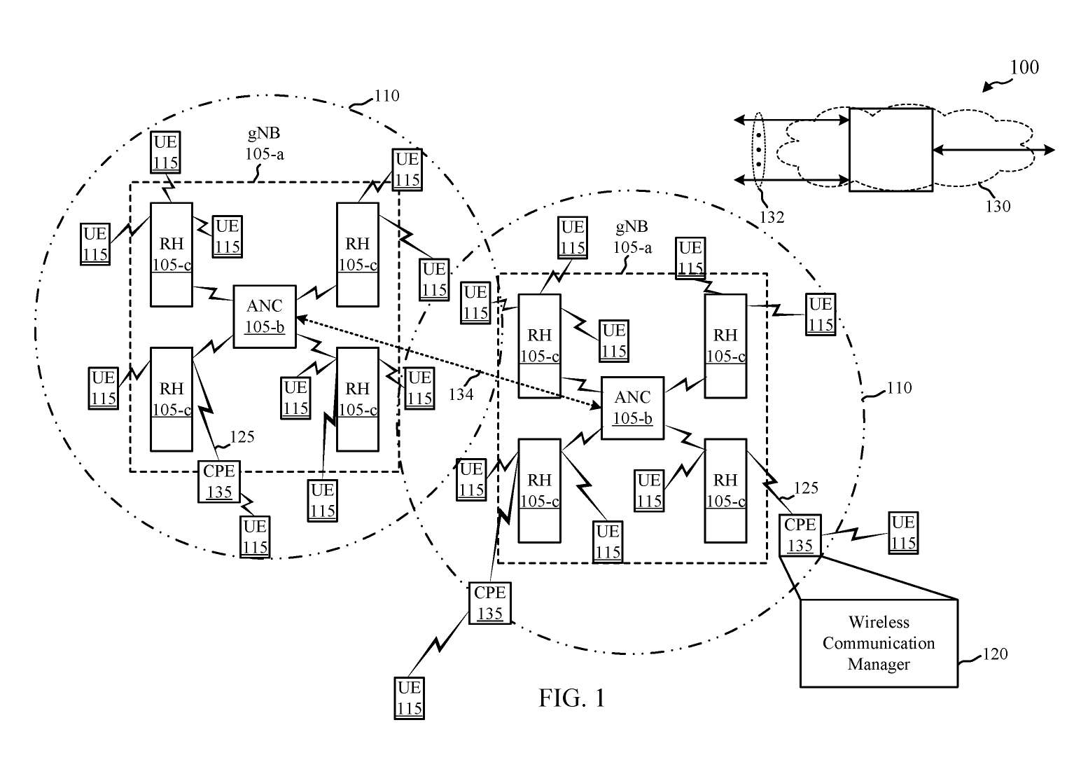

FIG. 1 shows an example of a wireless communication system 100, in accordance with one or more aspects of the disclosure. The wireless communication system 100 may include network access devices 105 (e.g., gNBs 105-a, ANCs 105-b, and/or RHs 105-c), UEs 115, and a core network 130. The core network 130 may provide user authentication, access authorization, tracking, Internet Protocol (IP) connectivity, and other access, routing, or mobility functions. At least some of the network access devices 105 (e.g., gNBs 105-a or ANCs 105-b) may interface with the core network 130 through backhaul links 132 (e.g., S1, S2, etc.) and may perform radio configuration and scheduling for communication with the UEs 115. In various examples, the ANCs 105-b may communicate, either directly or indirectly (e.g., through core network 130), with each other over backhaul links 134 (e.g., X1, X2, etc.), which may be wired or wireless communication links. Each ANC 105-b may also communicate with a number of UEs 115 through a number of smart radio heads (e.g., RHs 105-c). In an alternative configuration of the wireless communication system 100, the functionality of an ANC 105-b may be provided by a RH 105-c or distributed across the RHs 105-c of an gNB 105-a. In another alternative configuration of the wireless communication system 100 (e.g., an LTE/LTE-A configuration), the RHs 105-c may be replaced with base stations, the ANCs 105-b may be replaced by base station controllers (or links to the core network 130), and the gNBs 105-a may be replaced by eNBs. In some examples, the wireless communication system 100 may include a mix of RHs 105-c, base stations, and/or other network access devices 105 for receiving/transmitting communications according to different radio access technologies (RATs) (e.g., LTE/LTE-A, 5G, Wi-Fi, etc.).

A macro cell may cover a relatively large geographic area (e.g., several kilometers in radius) and may allow unrestricted access by UEs 115 with service subscriptions with a network provider. A small cell may include a lower-powered radio head or base station, as compared with a macro cell, and may operate in the same or different frequency band(s) as macro cells. Small cells may include pico cells, femto cells, and micro cells according to various examples. A pico cell may cover a relatively smaller geographic area and may allow unrestricted access by UEs 115 with service subscriptions with a network provider. A femto cell also may cover a relatively small geographic area (e.g., a home) and may provide restricted access by UEs 115 having an association with the femto cell (e.g., UEs in a closed subscriber group (CSG), UEs for users in the home, and the like). A gNB for a macro cell may be referred to as a macro gNB. A gNB for a small cell may be referred to as a small cell gNB, a pico gNB, a femto gNB or a home gNB. A gNB may support one or multiple (e.g., two, three, four, and the like) cells (e.g., component carriers).

In some examples, the wireless communication system 100 may include CPEs 135. A CPE 135 may take various forms and may be a demarcation point between a customer's premises (e.g., a home, store, office building, or other venue) and a network. A CPE 135 may include, for example, a wireless relay or a wireless router, and may provide communication between one or more network access devices (e.g., one or more RHs 105-c) and one or more UEs 115.

The wireless communication system 100 may support synchronous or asynchronous operation. For synchronous operation, the gNBs 105-a and/or RHs 105-c may have similar frame timing, and transmissions from different gNBs 105-a and/or RHs 105-c may be approximately aligned in time. For asynchronous operation, the gNBs 105-a and/or RHs 105-c may have different frame timings, and transmissions from different gNBs 105-a and/or RHs 105-c may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use Hybrid ARQ (HARD) to provide retransmission at the MAC layer to improve link efficiency. In the control plane, the Radio Resource Control (RRC) protocol layer may provide establishment, configuration, and maintenance of an RRC connection between a UE 115 and a RH 105-c, ANC 105-b, or core network 130 supporting radio bearers for user plane data. At the Physical (PHY) layer, transport channels may be mapped to physical channels.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, an Internet of Everything (IoE) device, etc. A UE 115 may be able to communicate with various types of network access devices 105 (e.g., gNBs 105-a, RHs 105-c, eNBs, base stations, access points, macro gNBs, small cell gNBs, relay base stations, and the like) or CPEs 135. A UE 115 may also be able to communicate directly with other UEs 115 (e.g., using a peer-to-peer (P2P) protocol).

The communication links 125 shown in wireless communication system 100 may include uplinks from a UE 115 to a RH 105-c (and in some examples through a CPE 135), and/or downlinks, from a RH 105-c to a UE 115 (and in some examples through a CPE 135). The downlinks may also be called forward links, while the uplinks may also be called reverse links. Control information and data may be multiplexed on an uplink or downlink according to various techniques. Control information and data may be multiplexed on an uplink or downlink, for example, using time division multiplexing (TDM) techniques, frequency division multiplexing (FDM) techniques, or hybrid TDM-FDM techniques.

Each communication link 125 may include one or more carriers, where each carrier may be a signal made up of multiple sub-carriers (e.g., waveform signals of different frequencies) modulated according to one or more radio access technologies. Each modulated signal may be sent on a different sub-carrier and may carry control information (e.g., reference signals, control channels, etc.), overhead information, user data, etc. The communication links 125 may transmit bidirectional communications using frequency division duplexing (FDD) techniques (e.g., using paired spectrum resources) or time division duplexing techniques (e.g., using unpaired spectrum resources). Frame structures for FDD (e.g., frame structure type 1) and TDD (e.g., frame structure type 2) may be defined.

In some examples of the wireless communication system 100, a network access device 105 (e.g., RHs 105-c), CPE 135, or UE 115 may include multiple antennas (e.g., an antenna array) for employing antenna diversity schemes to improve communication quality and reliability between network access devices 105, CPEs 135, and UEs 115. Additionally or alternatively, network access devices 105, CPEs 135, and UEs 115 may employ multiple-input, multiple-output (MIMO) techniques that may take advantage of multi-path environments to transmit multiple spatial layers carrying the same or different coded data. For example, wireless communication system may use a transmission scheme between a transmitting device and a receiving device, where the transmitting device is equipped with multiple antennas and the receiving devices are equipped with one or more antennas.

Beamforming, which may also be referred to as spatial filtering, directional transmission, or directional reception, is a signal processing technique that may be used at a transmitting device or a receiving device (e.g., a base station 105, a UE 115, a CPE 135, etc.) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the antennas of a base station 105, UE 115, or CPE 135 may be located within one or more antenna arrays, which may support MIMO operations, transmit beamforming, and/or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 or CPE 135 may have one or more antenna arrays that may support various MIMO or beamforming operations.

The wireless communication system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

In some examples, a wireless device (e.g., a CPE 135, a UE 115, or a network access device (e.g., a RH 105-c)) of the wireless communication system may include a wireless communication manager 120. The wireless communication manager 120 may be used to detect an object within an energy mitigation area proximate to the wireless device. The wireless communication manager 120 may also be used to determine an allowable energy density at the object based at least in part on the object detection, and to adjust at least one RF transmission parameter of the wireless device based at least in part on the allowable energy density at the object.

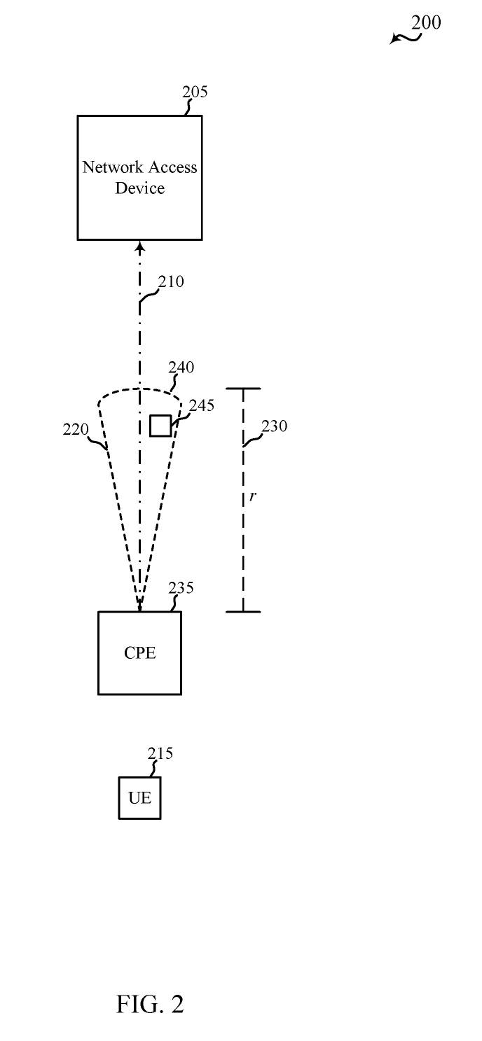

FIG. 2 shows a CPE 235 that may provide RF exposure mitigation for objects proximate to the CPE 235, in accordance with various aspects of the present disclosure. As shown, the CPE 235 may facilitate communication between a network access device 205 and a UE 215, and may communicate with both the network access device 205 and the UE 215 wirelessly. In some examples, the CPE 235, network access device 205, and UE 215 may be examples of aspects of the CPEs 135, network access devices 105, and UEs 115 described with reference to FIG. 1.

In some examples, the CPE 235 may transmit a beamformed transmission 210 to the network access device 205. Because the beamformed transmission may have a higher RF transmit power, there may be a higher probability that the energy density of the beamformed transmission exceeds a desired or maximum energy density—especially near the CPE 235 or within an energy mitigation area 220 proximate to the CPE 235.

In some examples, the CPE 235 may be preconfigured with one or more parameters defining the energy mitigation area 220, or may receive one or more parameters defining the energy mitigation area 220. In some examples, the CPE 235 may determine one or more parameters of the energy mitigation area 220. For example, the CPE 235 may determine at least one beamforming parameter (e.g., at least one of an optimal beamforming direction, a beamforming pattern, etc.) to communicate with the network access device 205. The CPE 235 may also determine a maximum value of at least one RF transmission parameter (e.g., at least one of a maximum RF transmission duty cycle of the CPE 235, a maximum RF transmit power of the CPE 235, etc.) to communicate with the network access device 205. The CPE 235 may then determine the energy mitigation area 220 based at least in part on the at least one beamforming parameter and the maximum value of the at least one RF transmission parameter. In some examples, the energy mitigation area 220 may be defined by a radius 230 and an arc 240 or projection zone relative to the CPE 235. In some examples, the radius 230 may be based at least in part on the RF transmission parameter(s), the center point of the arc 240 or projection zone may be based at least in part on the beamforming parameter(s), and the extent of the arc 240 or projection zone may be based at least in part on the RF transmission parameter(s) and the beamforming parameter(s).

In some examples, the CPE 235 may perform RF exposure mitigation for objects within the energy mitigation area 220. When no object is present within the energy mitigation area 220 (or no object, such as a potential living organism, having a parameter that exceeds a threshold is within the energy mitigation area 220), the CPE 235 may not perform RF exposure mitigation. Otherwise, when an object is present within the energy mitigation area 220, the CPE 235 may or may not perform RF exposure mitigation. In some examples, the CPE 235 may perform RF exposure mitigation based on an over-ridable assumption that an object is a living organism (e.g., a person, animal, or bird), or based on a detected characteristic (or characteristics) of the object, which characteristic may be a characteristic of a living organism. Upon receiving an indication from a user of the CPE 235 that the detected object is not a living organism or that RF exposure mitigation should not be performed for the object, or upon detecting an object that does not have a characteristic (or characteristics) of a living organism, the CPE 235 may not perform RF exposure mitigation.

In some cases, the CPE 235 may have one or more sensors for detecting the presence (and possibly the size) of an object (e.g., object 245) within the energy mitigation area 220. The sensor(s) may also determine a distance between the CPE 235 and object 245. In some examples, the presence and distance to object 245 within the energy mitigation area 220 may be detected or determined using at least one ultrasound sensor. For example, when an ultrasound sensor detects object 245 within the energy mitigation area 220, the CPE 235 may determine an allowable energy density at the location of object 245. In some examples, the allowable energy density may be determined based at least in part on a determined distance between the CPE 235 and object 245. For example, the determined distance may be used as an index into an allowable energy density table, or the determined distance may be used as an input to a rule for determining an allowable energy density. In some examples, the allowable energy density may be determined based at least in part on a directionality of RF energy emitted by the CPE 235 (e.g., as determined by beamforming parameters or coefficients), antenna selection, antenna sub-array selection, or other parameters determined, for example, during establishment of one or more communication links with one or more other wireless devices (e.g., the network access device 205 or UE 215). The determined allowable energy density may be used to adjust at least one RF transmission parameter of the CPE 235. In some examples, adjusting the RF transmission parameter(s) may include altering a RF transmission duty cycle of the CPE 235, altering a RF transmit power of the CPE 235, altering a beamforming parameter of the CPE 235 (e.g., selecting at least one beamforming coefficient of the CPE 235, selecting a different beam pattern of a same antenna or antenna sub-array, selecting a different antenna, selecting a different antenna sub-array, or a combination thereof, where the selecting directs RF energy away from the detected object 245 while maintaining an acceptable RF communication link with network access device 205 or UE 215). In some examples, adjusting the RF transmit power may include reducing the RF transmit power of the CPE 235 or ceasing RF transmissions of the CPE 235.

In a first set of examples, the CPE 235 may notify a user of the CPE 235 upon detecting the object 245 within the energy mitigation area 220. In some examples, the notification may take the form of triggering a proximity alarm (e.g., illuminating a reset button, displaying a message, transmitting a notification to the user's mobile device, etc.). When the user notices a living organism (e.g., a person, animal, or bird) within the energy mitigation area 220, the user may not respond to the notification. When the CPE 235 does not receive a response to the notification, the CPE 235 may maintain its adjustment of the RF transmission parameter(s) of the CPE 235, based at least in part on the allowable energy density at the object 245. Alternatively, when the user does not believe a living organism is within the energy mitigation area 220, and believes the detected object may be an object such as a wall or a window, the user may provide a reset indication to the CPE 235 (e.g., the user may press a reset button or provide a reset indication through another user interface, on or remote from the CPE 235). When the CPE 235 receives the reset indication, the CPE 235 may optionally determine a distance between the CPE 235 and the object 245 (e.g., at or about the time the reset indication is received), and the CPE 235 may cease to adjust (e.g., or reset) the RF transmission parameter(s) of the CPE 235 based on object detection at the determined distance (e.g., at the distance determined after detecting the object 245, or at the distance determined after receiving the reset indication).

In some examples, the CPE 235 may enable (e.g., re-enable) adjustment of the RF transmission parameter(s) of the CPE 235, based on object detection at the determined distance, in response to detecting a predetermined trigger condition. The trigger condition may include, for example, movement of the CPE 235, enablement of RF transmission parameter adjustment at the CPE 235 (e.g., receipt of an enabling user input), or a combination thereof.

In a second set of examples, the CPE 235 may have one or more sensors that detect not only the presence and possibly the size of an object (e.g., the object 245) within the energy mitigation area 220, but also whether the object has at least one characteristic of a living organism. The sensor(s) may also determine a distance between the CPE 235 and the object 245. In some examples, the sensor(s) may include at least one ultrasound sensor and at least one of a passive or active infrared sensor, an imaging device (e.g., a complimentary metal-oxide semiconductor (CMOS) image sensor), a thermal imaging device, or a combination thereof. When the sensor(s) detect an object 245 that does not have at least one characteristic of a living organism within the energy mitigation area 220, the CPE 235 may not employ RF exposure mitigation. Otherwise, when the sensor(s) detect an object 245 that has at least one characteristic of a living organism within the energy mitigation area 220, the CPE 235 may determine an allowable energy density at the object 245.

In some examples, the allowable energy density may be determined based at least in part on a determined distance between the CPE 235 and the object 245. For example, the determined distance may be used as an index into an allowable energy density table, or the determined distance may be used as an input to a rule for determining an allowable energy density. In some examples, the allowable energy density may be determined based at least in part on a directionality of RF energy emitted by the CPE 235 (e.g., as determined by beamforming parameters, antenna selection, antenna sub-array selection, or other parameters determined, for example, during establishment of one or more communication links with the network access device 205 or UE 215). The determined allowable energy density may be used to adjust at least one RF transmission parameter of the CPE 235. In some examples, adjusting the RF transmission parameter(s) may include altering a RF transmission duty cycle of the CPE 235, altering a RF transmit power of the CPE 235, altering a beamforming parameter of the CPE 235 (e.g., selecting at least one beamforming coefficient of the CPE 235, a different beam pattern of a same antenna or antenna sub-array, a different antenna, or a different antenna sub-array, to direct RF energy away from the detected object 245 while maintaining an acceptable RF communication link with the network access device 205 or UE 215), or a combination thereof. In some examples, adjusting the RF transmit power may include reducing the RF transmit power of the CPE 235 or ceasing RF transmissions of the CPE 235.

In the second set of examples, the CPE 235 may notify a user of the CPE 235 upon adjusting the RF transmission parameter(s) of the CPE 235. In some examples, the notification may take the form of triggering a proximity alarm (e.g., illuminating a reset button, displaying a message, transmitting a notification to the user's mobile device, etc.). When the user notices a living organism (e.g., a person, animal, or bird) within the energy mitigation area 220, the user may not respond to the notification. When the CPE 235 does not receive a response to the notification, the CPE 235 may maintain its adjustment of the RF transmission parameter(s) of the CPE 235, based at least in part on the allowable energy density at the object 245. Alternatively, when the user does not believe a living organism is within the energy mitigation area 220 and believes the detected object may be an object that was incorrectly determined to have at least one characteristic of a living organism, the user may provide a reset indication to the CPE 235 (e.g., the user may press a reset button or provide a reset indication through another user interface, on or remote from the CPE 235). When the CPE 235 receives the reset indication, the CPE 235 may cease to adjust the RF transmission parameter(s) of the CPE 235 based on the detected object.

In the second set of examples, the CPE 235 may detect movement of the object 245 to a new location within the energy mitigation area 220, and in some examples may determine a new allowable energy density and make additional or different RF parameter adjustments based on the new allowable energy density. The CPE 235 may also detect movement of the object 245 to a location outside the energy mitigation area 220, and may discontinue any RF parameter adjustments for the object 245 when the object 245 moves to the location outside the energy mitigation area 220.

In either the first or second set of examples, the CPE 235 may detect movement of the CPE 235, and may cease RF transmissions of the CPE 235 while the CPE 235 is moving. In some examples, object detection may also be suspended while the CPE 235 is moving. In some examples, RF transmissions (and in some examples, object detection) may be discontinued until the CPE 235 stops moving, or until RF transmission (and in some examples, object detection) is re-enabled by user interaction with the CPE 235 (e.g., through a reset button or other user interface, on or remote from the CPE 235).

In some examples, RF exposure mitigation may also or alternatively be provided for objects proximate to the CPE 235, based on transmissions from the CPE 235 to the UE 215. RF exposure mitigation may also or alternatively be provided for objects proximate to the UE 215, based on transmissions from the UE 215 to the CPE 235 or network access device 205, or for objects proximate to the network access device 205, based on transmissions from the network access device 205 to the CPE 235 or UE 215.

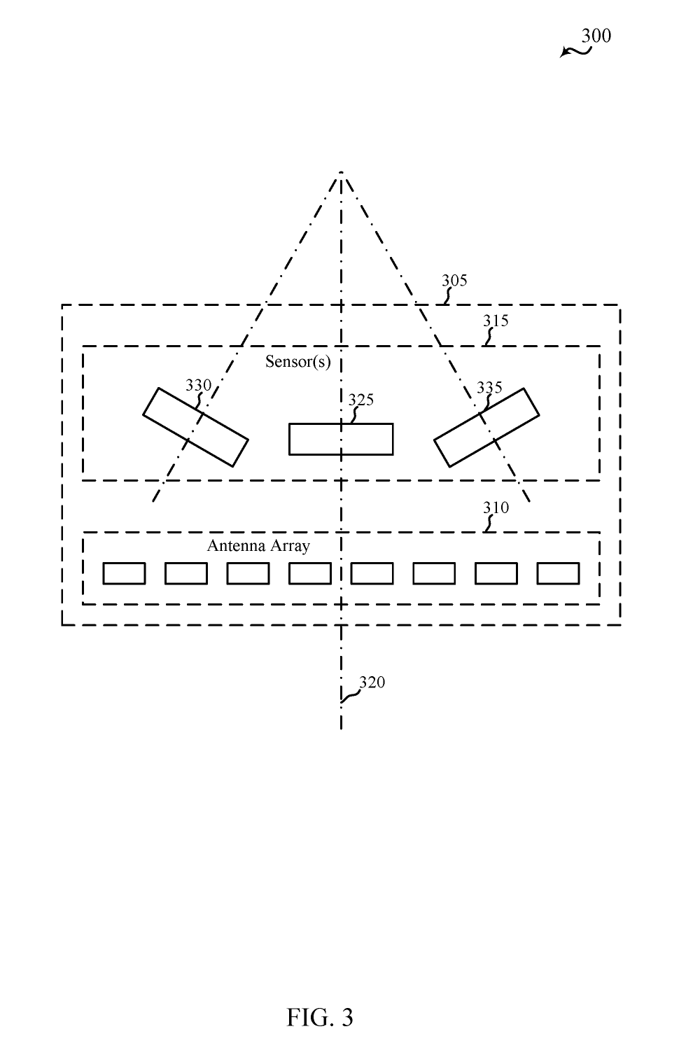

FIG. 3 shows a block diagram 300 of an apparatus 305 including an antenna array 310 and at least one sensor 315, in accordance with various aspects of the present disclosure. The apparatus 305 may be included in a wireless device (e.g., a CPE, a UE, or a network access device), and may be operated to provide RF exposure mitigation for objects proximate to the apparatus 305 or antenna array 310.

In some examples, the antenna array 310 may be used to transmit a beamformed transmission to another wireless device. Because the beamformed transmission may have a higher RF transmit power than a non-beamformed transmission, there may be a higher probability that the energy density of the beamformed transmission exceeds a desired or maximum energy density—especially near the antenna array 310 or within an energy mitigation area proximate to the apparatus 305 or antenna array 310. In some examples, the sensor(s) 315 and antenna array 310 may be operated to provide RF exposure mitigation for objects as described with reference to FIG. 2.

In some examples, the sensor(s) 315 may be positioned or calibrated to facilitate object detection within an energy mitigation area, or within a range of potential energy mitigation areas, proximate to the apparatus 305 or antenna array 310. In some examples, the sensor(s) 315 may include one or more of an ultrasound sensor (e.g., for a range of about 10 centimeters (cm) to 1.5 meters (m)), a passive or active infrared sensor, an imaging device (e.g., a CMOS image sensor), a thermal imaging device, a capacitive sensor (e.g., for a range under 10-15 cm), a radar object detector, or a combination thereof. The sensor(s) 315 may also include a sensor such as an accelerometer (e.g., to detect movement of the antenna array 310 and/or apparatus 305).

In some examples, more than one sensor may be used to detect an object, and in some examples, more than one sensor of the same type may be used to detect an object (e.g., an array of ultrasonic sensors may be used to provide object detection coverage for an energy mitigation area). When the apparatus 305 includes multiple antenna arrays, the same sensor (or same set of sensors) or different sensors (or different sets of sensors) may be used to detect objects within the energy mitigation areas of different antenna arrays. Similarly, when a reset button is provided to notify a user of object detection, different reset buttons may be provided for different antenna arrays. In some examples, a reset button may be directly illuminated to indicate object detection, or a light emitting diode (LED) or other illumination device may be lit near the reset button.

In some examples, the antenna array 310 may include a plurality of antennas (or antenna sub-arrays) positioned in a plane that intersects a bore axis 320 of the apparatus 305. In these examples, and by way of further example, the sensor(s) 315 may include an ultrasonic sensor 325, a first active infrared sensor 330, and a second active infrared sensor 335. In operation, an energy mitigation area may be determined for the apparatus 305. The energy mitigation area may be determined based at least in part on the antenna, antenna subarray, RF transmission beam, and RF transmit power selected for wireless communication with a second apparatus. Upon one or more of the sensor(s) 315 detecting an object within the energy mitigation area, the distance to the object and the angular sector of the object within the energy mitigation area may be determined. In some examples, a plurality of sensors 315 may be oriented to detect objects, or characteristics of objects, within different angular sectors of an energy mitigation area, and the detection of an object by one or more of the sensors 315 may allow an apparatus to determine the angular sector in which a detected object is located.

In some examples, each of the angular sectors may correspond to a set of RF transmission beams. In some examples, the sensor(s) 315 may have overlapping angular object detection zones. In some examples, a beam scan may be performed for the antenna selected for communication with the second apparatus, and if other antenna subarrays are available for the antenna, the apparatus 305 may determine whether one or more other antenna subarrays may be used for communication with the second apparatus. The apparatus 305 may then calculate the RF transmit power, RF transmission duty cycle, and data rate needed for each antenna, antenna subarray, and RF transmission beam combination (or option) to maintain a minimum quality level of communication with the second apparatus. Quality level may be based on a signal-to-noise ratio (SNR) and/or packet/frame error rate for each option. Quality levels can be calculated by the apparatus 305 or determined from feedback received from the second apparatus during a beam selection process. The apparatus 305 may also calculate a maximum RF transmit power and maximum RF transmission duty cycle for each antenna, antenna subarray, and RF transmission beam combination (or option), and for the currently used antenna, antenna subarray, and RF transmission beam combination (or option), that comports with the allowable energy density at the detected object. The apparatus 305 may then rank the combinations (or options) based on their ability to provide the best communication quality for communication with the second apparatus, while also satisfying the allowable energy density at the detected object, and a best combination (or option) may be selected for communication with the second apparatus.

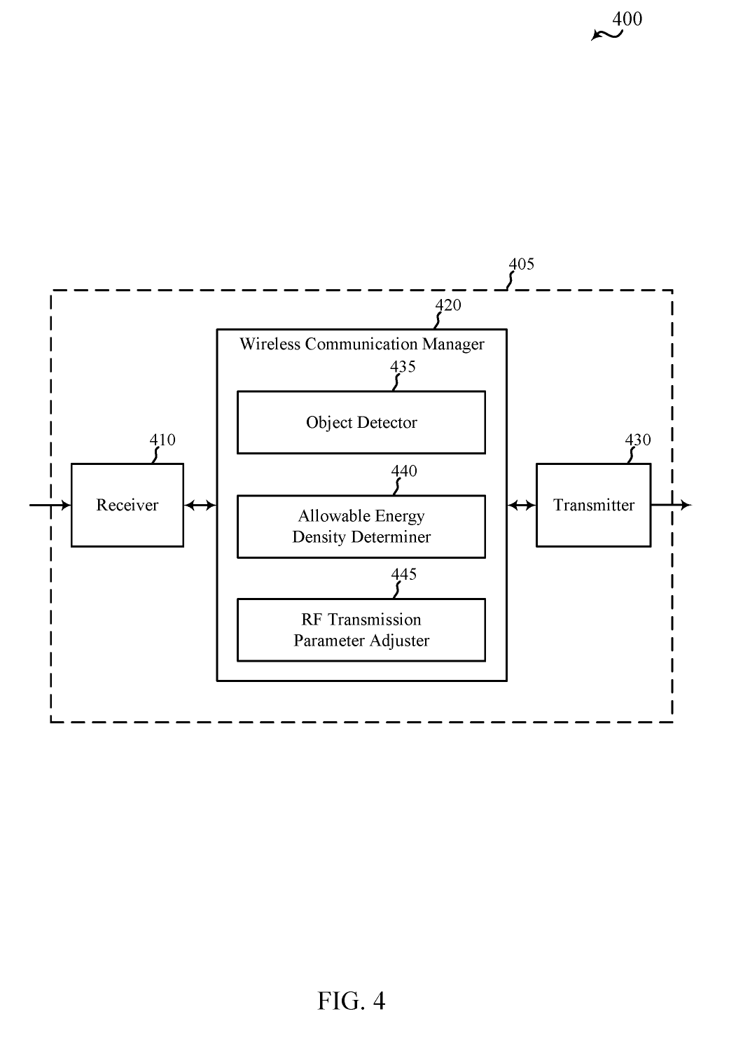

FIG. 4 shows a block diagram 400 of an apparatus 405 for use in wireless communication, in accordance with one or more aspects of the present disclosure. The apparatus 405 may be an example of aspects of one or more of the wireless devices (e.g., CPEs, UEs, or network access devices described with reference to FIG. 1, 2, or 3. The apparatus 405 may also be or include a processor. The apparatus 405 may include a receiver 410, a wireless communication manager 420, or a transmitter 430. Each of these components may be in communication with each other.

The components of the apparatus 405 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In some other examples, other types of integrated circuits may be used (e.g., Structured/Platform ASICs, Field Programmable Gate Arrays (FPGAs), a System-on-Chip (SoC), and/or other types of Semi-Custom ICs), which may be programmed in any manner known in the art. The functions of each component may also be implemented, in whole or in part, with instructions embodied in a memory, formatted to be executed by one or more general or application-specific processors.

In some examples, the receiver 410 may include at least one RF receiver, such as at least one RF receiver operable to receive transmissions over one or more radio frequency spectrum bands. In some examples, the one or more radio frequency spectrum bands may be used for communicating as described with reference to FIG. 1, 2, or 3. The receiver 410 may be used to receive various types of data or control signals (i.e., transmissions) over one or more communication links of a wireless communication system, such as one or more communication links of the wireless communication system 100 described with reference to FIG. 1.

In some examples, the transmitter 430 may include at least one RF transmitter, such as at least one RF transmitter operable to transmit over one or more radio frequency spectrum bands. In some examples, the one or more radio frequency spectrum bands may be used for communicating as described with reference to FIG. 1, 2, or 3. The transmitter 430 may be used to transmit various types of data or control signals (i.e., transmissions) over one or more communication links of a wireless communication system, such as one or more communication links of the wireless communication system 100 described with reference to FIG. 1.

In some examples, the wireless communication manager 420 may be used to manage one or more aspects of wireless communication for the apparatus 405. In some examples, part of the wireless communication manager 420 may be incorporated into or shared with the receiver 410 or the transmitter 430. In some examples, the wireless communication manager 420 may include an object detector 435, an allowable energy density determiner 440, or a RF transmission parameter adjuster 445.

The object detector 435 may be used to detect an object within an energy mitigation area proximate to the apparatus. The allowable energy density determiner 440 may be used to determine an allowable energy density at the object based at least in part on the object detection. The RF transmission parameter adjuster 445 may be used to adjust at least one RF transmission parameter of the apparatus based at least in part on the allowable energy density at the object. In some examples, adjusting the at least one RF transmission parameter may include altering a RF transmission duty cycle of the apparatus 405, altering a RF transmit power of the apparatus 405, altering a beamforming parameter of the apparatus 405 (e.g., selecting at least one beamforming coefficient of the apparatus 405, a different beam pattern of a same antenna or antenna sub-array, a different antenna, or a different antenna sub-array, to direct RF energy away from the detected object while maintaining an acceptable RF communication link with one or more wireless devices), or a combination thereof. In some examples, adjusting the RF transmit power may include reducing the RF transmit power or ceasing RF transmissions.

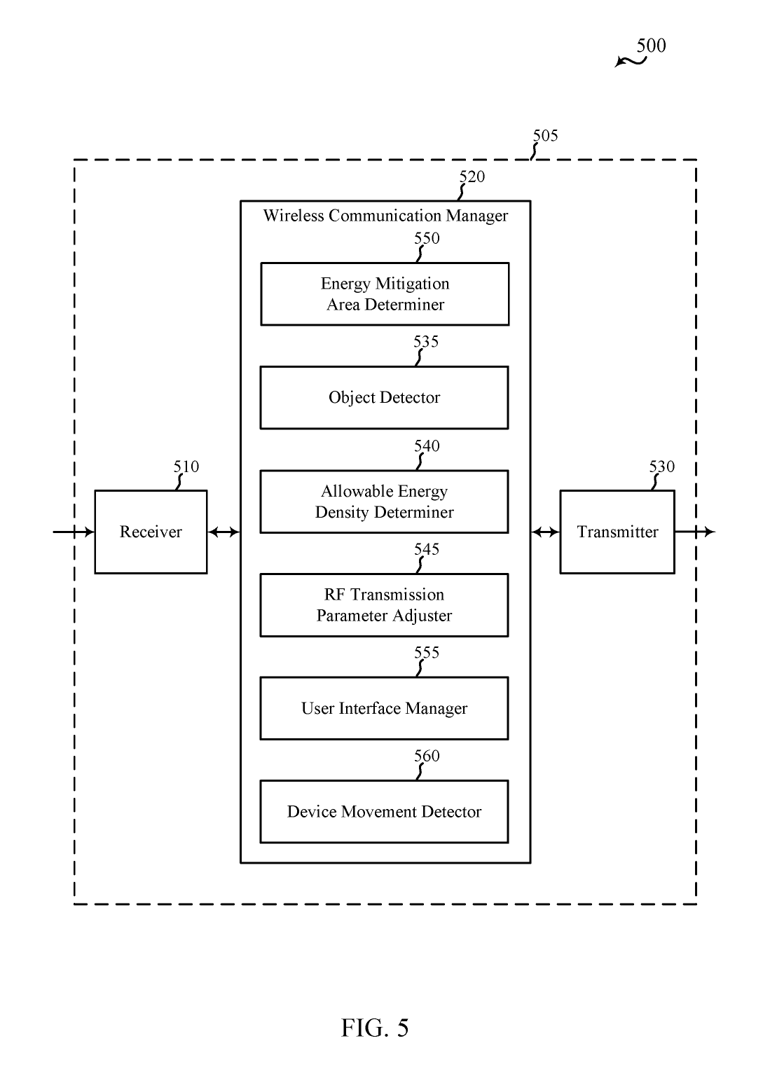

FIG. 5 shows a block diagram 500 of a wireless communication manager 520 for use in wireless communication, in accordance with one or more aspects of the present disclosure. The wireless communication manager 520 may be an example of aspects of the wireless communication manager 420 described with reference to FIG. 4.

The components of the wireless communication manager 520 may, individually or collectively, be implemented using one or more ASICs adapted to perform some or all of the applicable functions in hardware. Alternatively, the functions may be performed by one or more other processing units (or cores), on one or more integrated circuits. In some other examples, other types of integrated circuits may be used (e.g., Structured/Platform ASICs, FPGAs, a SoC, and/or other types of Semi-Custom ICs), which may be programmed in any manner known in the art. The functions of each component may also be implemented, in whole or in part, with instructions embodied in a memory, formatted to be executed by one or more general or application-specific processors.

In some examples, the wireless communication manager 520 may be used to manage one or more aspects of wireless communication at a wireless device (e.g., a CPE, a UE, or a network access device), such as one of the wireless devices described with reference to FIG. 1, 2, 3, or 4. In some examples, part of the wireless communication manager 520 may be incorporated into or shared with a receiver or a transmitter (e.g., the receiver 410 or transmitter 430 described with reference to FIG. 4). In some examples, the wireless communication manager 520 may include an energy mitigation area determiner 550, an object detector 535, an allowable energy density determiner 540, a RF transmission parameter adjuster 545, a user interface manager 555, or a device movement detector 560.

The energy mitigation area determiner 550 may be used to determine at least one beamforming parameter (e.g., at least one of an optimal beamforming direction of the wireless device that includes the wireless communication manager 520, a beamforming pattern of the wireless device, etc.) to communicate with a second wireless device. The energy mitigation area determiner 550 may also be used to determine a maximum value of at least one RF transmission parameter (e.g., at least one of a maximum RF transmission duty cycle of the wireless device, a maximum RF transmit power of the wireless device, etc.) to communicate with the second wireless device. The energy mitigation area determiner 550 may also be used to determine an energy mitigation area proximate to the wireless device, based at least in part on the at least one beamforming parameter and the maximum value of the at least one RF transmission parameter. In some examples, the energy mitigation area may be defined by a distance (e.g., a radius) and an arc or projection zone relative to the wireless device.

The object detector 535 may be used to detect an object within the energy mitigation area. In some examples, detecting the object within the energy mitigation area may include detecting that the object has at least one characteristic of a living organism. In some examples, detecting that the object has at least one characteristic of a living organism may include detecting a movement of the object, a capacitance of the object, a thermal energy of the object, or a combination thereof. In some examples, movement of the object may be detected based on infrared motion sensing, image processing, thermal imaging, or a combination thereof. Detecting the object within the energy mitigation area may also include determining a distance between the wireless device and the object.

The allowable energy density determiner 540 may be used to determine an allowable energy density at the object based at least in part on the object detection. In some examples, the allowable energy density may be determined based at least in part on a determined distance between the wireless device and the object. In some examples, the allowable energy density may be determined based at least in part on a directionality of RF energy emitted by the wireless device (e.g., as determined by beamforming parameters (e.g., beamforming coefficients), antenna selection, antenna sub-array selection, or other parameters determined, for example, during establishment of one or more communication links with one or more other wireless devices).

The RF transmission parameter adjuster 545 may be used to adjust at least one RF transmission parameter of the wireless device based at least in part on the allowable energy density at the object. In some examples, adjusting the at least one RF transmission parameter may include altering a RF transmission duty cycle of the wireless device, altering a RF transmit power of the wireless device, altering a beamforming parameter of a wireless device that includes the wireless communication manager 520 (e.g., selecting at least one beamforming coefficient of the wireless device, a different beam pattern of a same antenna or antenna sub-array, a different antenna, or a different antenna sub-array, to direct RF energy away from the detected object while maintaining an acceptable RF communication link with one or more other wireless devices), or a combination thereof. In some examples, adjusting the RF transmit power may include reducing the RF transmit power or ceasing RF transmissions. In some examples, the RF transmission parameter adjuster 545 may be used to further adjust the at least one RF transmission parameter of the wireless device based at least in part on a quality of a RF communication link between the wireless device and a second wireless device. In some examples, the RF transmission parameter adjuster 545 may determine a set of one or more RF transmission parameters for each of a plurality of antennas, antenna subarrays, RF transmission beams, or combinations thereof. In these latter examples, adjusting the at least one RF transmission parameter of the wireless device may include selecting one of the antennas, antenna subarrays, RF transmission beams, or combinations thereof.

In some examples, the user interface manager 555 may be used to notify a user of the wireless device upon detecting the object within the energy mitigation area. When the user interface manager 555 does not receive a response to the notification, the RF transmission parameter adjuster 545 may maintain its adjustment of the at least one RF transmission parameter of the wireless device, based at least in part on the allowable energy density at the object. When the user interface manager 555 receives a reset indication from the user (e.g., through a reset button or other user interface, on or remote from the wireless device), the object detector 535 may optionally determine a distance between the wireless device and the object (e.g., at or about the time the reset indication is received), and the RF transmission parameter adjuster 545 may cease to adjust the at least one RF transmission parameter of the wireless device, based on object detection at the distance determined after detecting the object or after receiving the reset indication. When a predetermined trigger condition is later detected, the RF transmission parameter adjuster 545 may enable (e.g., re-enable) adjustment of the at least one RF transmission parameter of the wireless device based on object detection at the determined distance. The trigger condition may include, for example, a movement of the wireless device detected by the device movement detector 560, an enablement of RF transmission parameter adjustment at the wireless device (e.g., an enablement in response to user input received by the user interface manager 555), or a combination thereof.

In examples of the wireless communication manager 520 in which the object detector 535 is able to detect movement of the object, the object detector 535 may be used to detect a movement of the object to a new location within the energy mitigation area. Detecting the movement of the object to the new location within the energy mitigation area may include determining a new distance between the wireless device and the object. In these examples, the allowable energy density determiner 540 may determine a new allowable energy density, if any, to be used for RF transmission parameter adjustment by the RF transmission parameter adjuster 545.

Also or alternatively in examples of the wireless communication manager 520 in which the object detector 535 is able to detect movement of the object, the device movement detector 560 may be used to detect a movement of the object to outside the energy mitigation area, and the RF transmission parameter adjuster 545 may cease to adjust the at least one RF transmission parameter of the wireless device, based at least in part on the allowable energy density at the object.

The device movement detector 560 may be used to detect a movement of the wireless device. The RF transmission parameter adjuster 545 may cease RF transmissions of the wireless device while the wireless device is moving. In some examples, object detection may also be ceased while the wireless device is moving. In some examples, RF transmissions (and in some examples, object detection) may be discontinued until the wireless device stops moving, or until RF transmission (and in some examples, object detection) is re-enabled by user interaction with the wireless device (e.g., through a reset button or other user interface, on or remote from the wireless device).

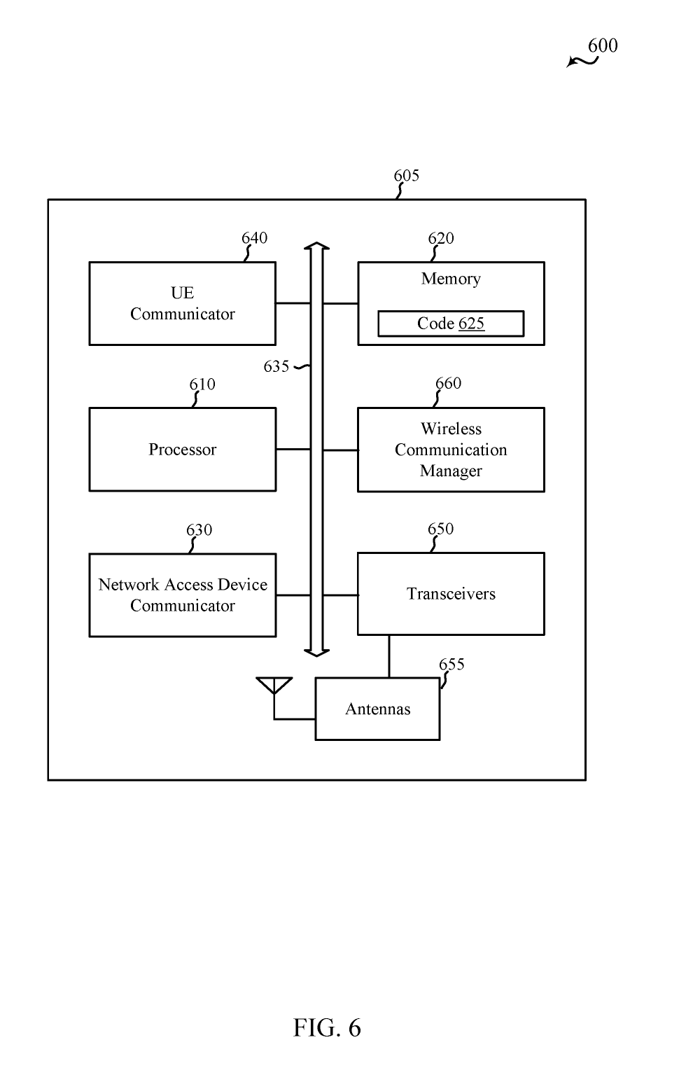

FIG. 6 shows a block diagram 600 of a CPE 605 for use in wireless communication, in accordance with one or more aspects of the present disclosure. In some examples, the CPE 605 (a type of wireless device) may be an example of one or more aspects of the CPEs described with reference to FIG. 1, 2, or 3, or aspects of the apparatus described with reference to FIG. 4. The CPE 605 may be configured to implement or facilitate at least some of the CPE, wireless device, or apparatus techniques or functions described with reference to FIG. 1, 2, 3, 4, or 5.

The CPE 605 may include a processor 610, a memory 620, transceivers 650, antennas 655 (e.g., an antenna array), or a wireless communication manager 660. The CPE 605 may also include one or more of a network access device communicator 630 or a UE communicator 640. Each of these components may be in communication with each other, directly or indirectly, over one or more buses 635.

The memory 620 may include random access memory (RAM) or read-only memory (ROM). The memory 620 may store computer-readable, computer-executable code 625 containing instructions that are configured to, when executed, cause the processor 610 to perform various functions described herein related to wireless communication, including, for example, detecting an object within an energy mitigation area proximate to the CPE 605, determining an allowable energy density at the object based at least in part on the object detection, and adjusting at least one RF transmission parameter of the CPE 605 based at least in part on the allowable energy density at the object. Alternatively, the computer-executable code 625 may not be directly executable by the processor 610 but be configured to cause the CPE 605 (e.g., when compiled and executed) to perform various of the functions described herein.

The processor 610 may include an intelligent hardware device, e.g., a central processing unit (CPU), a microcontroller, an ASIC, etc. The processor 610 may process or control the flow of information received through the transceivers 650 (e.g., under control of the network access device communicator 630 or UE communicator 640). The processor 610 may also process or control the flow of information to be sent to the transceivers 650 for transmission through the antennas 655 to a UE or network access device. The processor 610 may handle, alone or in connection with the wireless communication manager 660, one or more aspects of communication between one or more UEs and one or more network access devices over one or more radio frequency spectrum bands.

The transceivers 650 may include a modem configured to modulate packets and provide the modulated packets to the antennas 655 (or a subset thereof) for transmission to one or more UEs, and to demodulate packets received from the UE(s) via the antennas 655. The transceivers 650 may also include a modem configured to modulate packets and provide the modulated packets to the antennas 655 (or a subset thereof) for transmission to one or more network access devices, and to demodulate packets received from the network access device(s) via the antennas 655. In some examples, the transceivers 650 and antennas 655 may include different sets of transceivers and antennas for communicating with UEs or network access devices.

The transceivers 650 may, in some examples, be implemented as one or more transmitters and one or more separate receivers. The transceivers 650 may support communications in one or more radio frequency spectrum bands. The transceivers 650 may be configured to communicate bi-directionally, via the antennas 655, with one or more UEs and one or more network access devices, to facilitate communication between the UEs and the CPE 605, between the network access devices and the CPE 605, and/or between the UEs and the network access devices.

The wireless communication manager 660 may be configured to perform or control some or all of the CPE, wireless device, or apparatus techniques or functions described with reference to FIG. 1, 2, 3, 4, or 5. The wireless communication manager 660, or portions of it, may include a processor, or some or all of the functions of the wireless communication manager 660 may be performed by the processor 610 or in connection with the processor 610. In some examples, the wireless communication manager 660 may be an example of the wireless communication manager described with reference to FIG. 4 or 5.

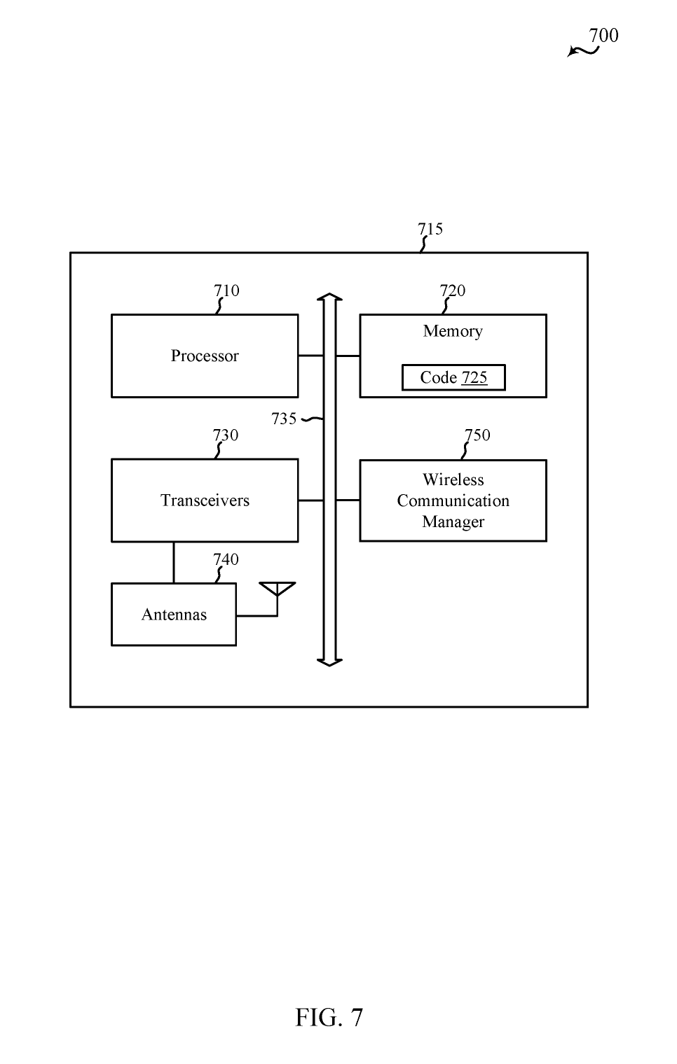

FIG. 7 shows a block diagram 700 of a UE 715 for use in wireless communication, in accordance with one or more aspects of the present disclosure. The UE 715 (a type of wireless device) may be included or be part of a personal computer (e.g., a laptop computer, a netbook computer, a tablet computer, etc.), a cellular telephone, a PDA, a digital video recorder (DVR), an internet appliance, a gaming console, an e-reader, a vehicle, a home appliance, a lighting or alarm control system, etc. The UE 715 may, in some examples, have an internal power supply (not shown), such as a small battery, to facilitate mobile operation. In some examples, the UE 715 may be an example of aspects of one or more of the UEs described with reference to FIG. 1, 2, or 3, or aspects of the apparatus described with reference to FIG. 4. The UE 715 may be configured to implement at least some of the UE, wireless device, or apparatus techniques or functions described with reference to FIG. 1, 2, 3, 4, or 5.

The UE 715 may include a processor 710, a memory 720, transceivers 730, antennas 740 (e.g., an antenna array), or a wireless communication manager 750. Each of these components may be in communication with each other, directly or indirectly, over one or more buses 735.

The memory 720 may include RAM or ROM. The memory 720 may store computer-readable, computer-executable code 725 containing instructions that are configured to, when executed, cause the processor 710 to perform various functions described herein related to wireless communication, including, for example, detecting an object within an energy mitigation area proximate to the UE 715, determining an allowable energy density at the object based at least in part on the object detection, and adjusting at least one RF transmission parameter of the UE 715 based at least in part on the allowable energy density at the object. Alternatively, the computer-executable code 725 may not be directly executable by the processor 710 but be configured to cause the UE 715 (e.g., when compiled and executed) to perform various of the functions described herein.

The processor 710 may include an intelligent hardware device, e.g., a CPU, a microcontroller, an ASIC, etc. The processor 710 may process information received through the transceivers 730, or information to be sent to the transceivers 730 for transmission through the antennas 740. The processor 710 may handle, alone or in connection with the wireless communication manager 750, one or more aspects of communicating over (or managing communications over) one or more radio frequency spectrum bands.

The transceiver(s) 730 may include a modem configured to modulate packets and provide the modulated packets to the antennas 740 for transmission, and to demodulate packets received from the antennas 740. The transceiver(s) 1230 may, in some examples, be implemented as one or more transmitters and one or more separate receivers. The transceivers 730 may support communications in one or more radio frequency spectrum bands. The transceivers 730 may be configured to communicate bi-directionally, via the antennas 740, with one or more other wireless devices (e.g., CPEs, network access devices, or other UEs).

The wireless communication manager 750 may be configured to perform or control some or all of the UE, wireless device, or apparatus techniques or functions described with reference to FIG. 1, 2, 3, 4, or 5. The wireless communication manager 750, or portions of it, may include a processor, or some or all of the functions of the wireless communication manager 750 may be performed by the processor 710 or in connection with the processor 710. In some examples, the wireless communication manager 750 may be an example of the wireless communication manager described with reference to FIG. 4 or 5.

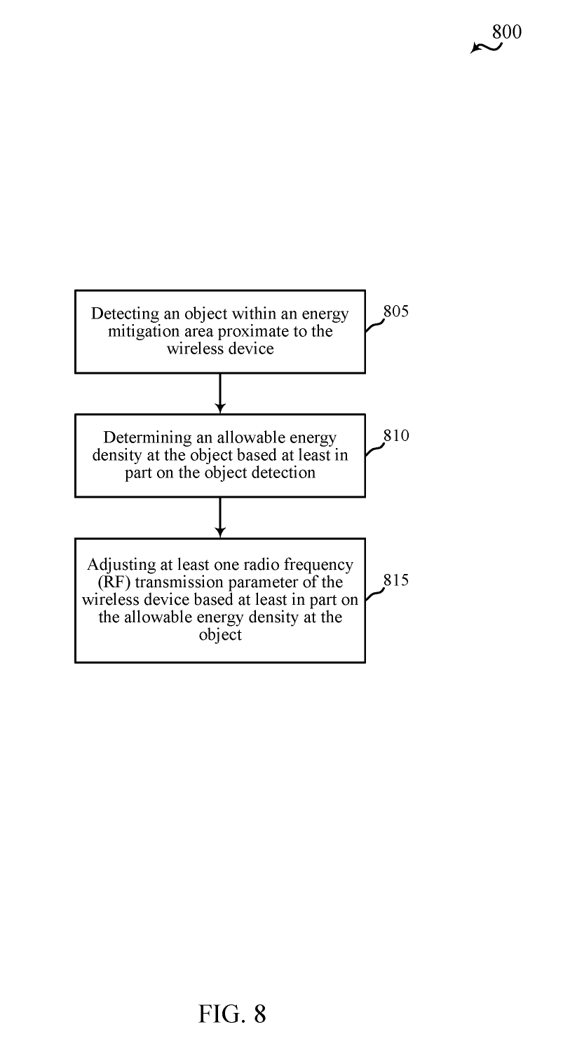

FIG. 8 is a flow chart illustrating an example of a method 800 for wireless communication at a wireless device (e.g., a CPE, UE, or network access device), in accordance with one or more aspects of the present disclosure. For clarity, the method 800 is described below with reference to aspects of one or more of the wireless devices described with reference to FIG. 1, 2, 3, 4, 5, 6, or 7, or aspects of one or more of the wireless communication managers described with reference to FIG. 4, 5, 6, or 7. In some examples, a wireless device may execute one or more sets of codes to control the functional elements of the wireless device to perform the functions described below. Additionally or alternatively, the wireless device may perform one or more of the functions described below using special-purpose hardware.

At 805, the method 800 may include detecting an object within an energy mitigation area proximate to the wireless device. In some examples, the operation(s) at 805 may be performed using the object detector 435 or 535 described with reference to FIG. 4 or 5.

At 810, the method 800 may include determining an allowable energy density at the object based at least in part on the object detection. In some examples, the operation(s) at 810 may be performed using the allowable energy density determiner 440 or 540 described with reference to FIG. 4 or 5.

At 815, the method 800 may include adjusting at least one RF transmission parameter of the wireless device based at least in part on the allowable energy density at the object. In some examples, adjusting the at least one RF transmission parameter may include altering a RF transmission duty cycle of the wireless device, altering a RF transmit power of the wireless device, or a combination thereof. In some examples, adjusting the RF transmit power may include reducing the RF transmit power or ceasing RF transmissions. In some examples, the at least one RF transmission parameter of the wireless device may be further adjusted based at least in part on a quality of a RF communication link between the wireless device and a second wireless device. In some examples, the method 800 may further include determining a set of one or more RF transmission parameters for each of a plurality of antennas, antenna subarrays, RF transmission beams, or combinations thereof. In these latter examples, adjusting the at least one RF transmission parameter of the wireless device may include selecting one of the antennas, antenna subarrays, RF transmission beams, or combinations thereof. In some examples, the operation(s) at 815 may be performed using the RF transmission parameter adjuster 445 or 545 described with reference to FIG. 4 or 5.

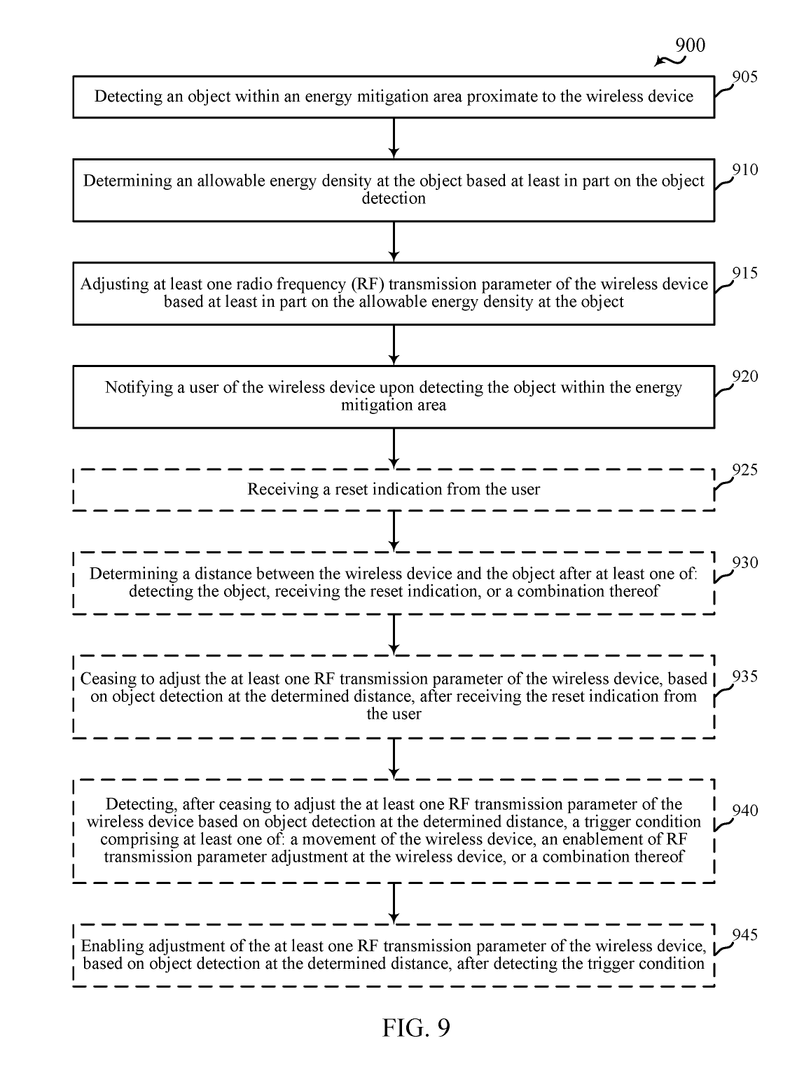

FIG. 9 is a flow chart illustrating an example of a method 900 for wireless communication at a wireless device (e.g., a CPE, UE, or network access device), in accordance with one or more aspects of the present disclosure. For clarity, the method 900 is described below with reference to aspects of one or more of the wireless devices described with reference to FIG. 1, 2, 3, 4, 5, 6, or 7, or aspects of one or more of the wireless communication managers described with reference to FIG. 4, 5, 6, or 7. In some examples, a wireless device may execute one or more sets of codes to control the functional elements of the wireless device to perform the functions described below. Additionally or alternatively, the wireless device may perform one or more of the functions described below using special-purpose hardware.

At 905, the method 900 may include detecting an object within an energy mitigation area proximate to the wireless device. Detecting the object within the energy mitigation area may include detecting that the object has at least one characteristic of a living organism. In some examples, detecting that the object has at least one characteristic of a living organism may include detecting a movement of the object, a capacitance of the object, a thermal energy of the object, or a combination thereof. In some examples, movement of the object may be detected based on infrared motion sensing, image processing, thermal imaging, or a combination thereof. Detecting the object within the energy mitigation area may also include determining a distance between the wireless device and the object. In some examples, the operation(s) at 905 may be performed using the object detector 435 or 535 described with reference to FIG. 4 or 5.

At 910, the method 900 may include determining an allowable energy density at the object based at least in part on the object detection. In some examples, the allowable energy density may be determined based at least in part on the determined distance between the wireless device and the object. In some examples, the allowable energy density may be determined based at least in part on a directionality of RF energy emitted by the wireless device (e.g., as determined by beamforming parameters (e.g., beamforming coefficients), antenna selection, antenna sub-array selection, or other parameters determined, for example, during establishment of one or more communication links with one or more other wireless devices). In some examples, the operation(s) at 910 may be performed using the allowable energy density determiner 440 or 540 described with reference to FIG. 4 or 5.

At 915, the method 900 may include adjusting at least one RF transmission parameter of the wireless device based at least in part on the allowable energy density at the object. In some examples, adjusting the at least one RF transmission parameter may include altering a RF transmission duty cycle of the wireless device, altering a RF transmit power of the wireless device, altering a beamforming parameter of the wireless device (e.g., selecting at least one beamforming coefficient of the wireless device, a different beam pattern of a same antenna or antenna sub-array, a different antenna, or a different antenna sub-array, to direct RF energy away from the detected object while maintaining an acceptable RF communication link with one or more other wireless devices), or a combination thereof. In some examples, adjusting the RF transmit power may include reducing the RF transmit power or ceasing RF transmissions. In some examples, the at least one RF transmission parameter of the wireless device may be further adjusted based at least in part on a quality of a RF communication link between the wireless device and a second wireless device. In some examples, the method 900 may further include determining a set of one or more RF transmission parameters for each of a plurality of antennas, antenna subarrays, RF transmission beams, or combinations thereof. In these latter examples, adjusting the at least one RF transmission parameter of the wireless device may include selecting one of the antennas, antenna subarrays, RF transmission beams, or combinations thereof. In some examples, the operation(s) at 915 may be performed using the RF transmission parameter adjuster 445 or 545 described with reference to FIG. 4 or 5.

At 920, the method 900 may include notifying a user of the wireless device upon detecting the object within the energy mitigation area. In some examples, the operation(s) at 920 may be performed using the user interface manager 555 described with reference to FIG. 5.

At 925, the method 900 may optionally include receiving a reset indication from the user. In some examples, the operation(s) at 925 may be performed using the user interface manager 555 described with reference to FIG. 5.

At 930, the method 900 may optionally include determining a distance between the wireless device and the object. The distance may be determined after receiving the reset indication. In some examples, the operation(s) at 930 may be performed using the object detector 435 or 535 described with reference to FIG. 4 or 5.

At 935, the method 900 may optionally include ceasing to adjust the at least one RF transmission parameter of the wireless device, based on object detection at the distance determined at 905 or 935, after receiving the reset indication from the user. In some examples, the operation(s) at 935 may be performed using the RF transmission parameter adjuster 445 or 545 described with reference to FIG. 4 or 5.

At 940, the method 900 may optionally include detecting, after ceasing to adjust the at least one RF transmission parameter of the wireless device based on object detection at the determined distance, a trigger condition including a movement of the wireless device, an enablement of RF transmission parameter adjustment at the wireless device, or a combination thereof. The distance may be determined after receiving the reset indication. In some examples, the operation(s) at 940 may be performed using the device movement detector 560 or user interface manager 555 described with reference to FIG. 5.

At 945, the method 900 may optionally include enabling adjustment of the at least one RF transmission parameter of the wireless device, based on object detection at the determined distance, after detecting the trigger condition. In some examples, the operation(s) at 945 may be performed using the RF transmission parameter adjuster 445 or 545 described with reference to FIG. 4 or 5.

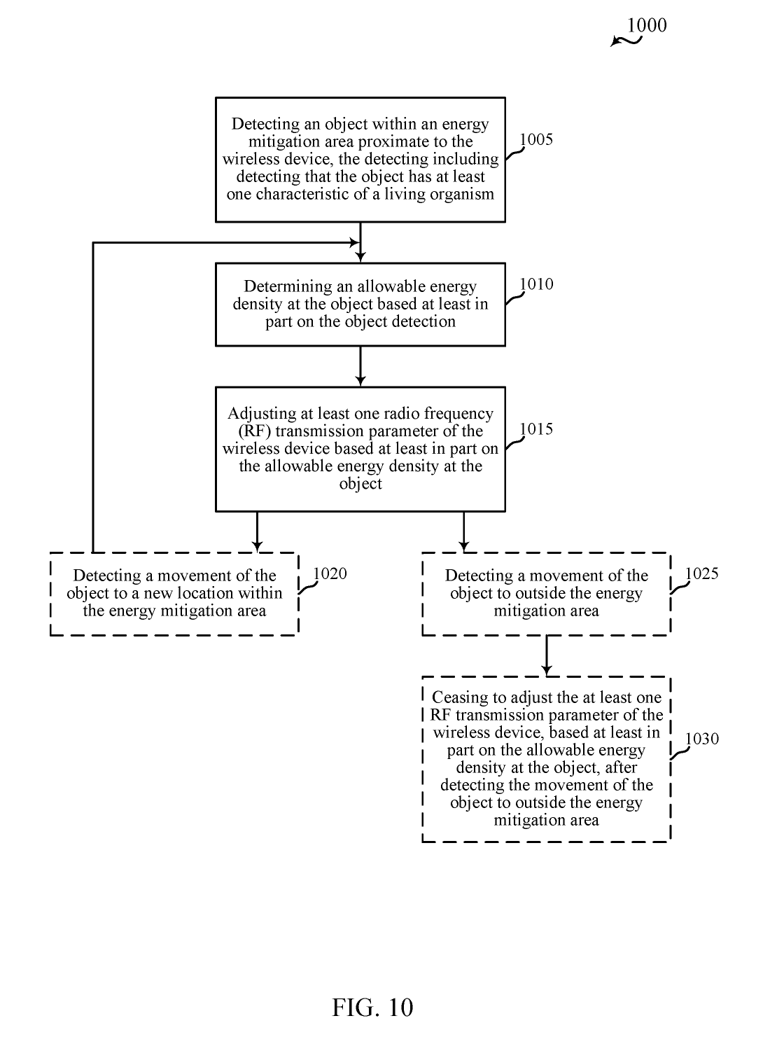

FIG. 10 is a flow chart illustrating an example of a method 1000 for wireless communication at a wireless device (e.g., a CPE, UE, or network access device), in accordance with one or more aspects of the present disclosure. For clarity, the method 1000 is described below with reference to aspects of one or more of the wireless devices described with reference to FIG. 1, 2, 3, 4, 5, 6, or 7, or aspects of one or more of the wireless communication managers described with reference to FIG. 4, 5, 6, or 7. In some examples, a wireless device may execute one or more sets of codes to control the functional elements of the wireless device to perform the functions described below. Additionally or alternatively, the wireless device may perform one or more of the functions described below using special-purpose hardware.

At 1005, the method 1000 may include detecting an object within an energy mitigation area proximate to the wireless device. Detecting the object within the energy mitigation area may include detecting that the object has at least one characteristic of a living organism. In some examples, detecting that the object has at least one characteristic of a living organism may include detecting a movement of the object, a capacitance of the object, a thermal energy of the object, or a combination thereof. In some examples, movement of the object may be detected based on infrared motion sensing, image processing, thermal imaging, or a combination thereof. Detecting the object within the energy mitigation area may also include determining a distance between the wireless device and the object. In some examples, the operation(s) at 1005 may be performed using the object detector 435 or 535 described with reference to FIG. 4 or 5.

At 1010, the method 1000 may include determining an allowable energy density at the object based at least in part on the object detection. In some examples, the allowable energy density may be determined based at least in part on the determined distance between the wireless device and the object. In some examples, the allowable energy density may be determined based at least in part on a directionality of RF energy emitted by the wireless device (e.g., as determined by beamforming parameters (e.g., beamforming coefficients), antenna selection, antenna sub-array selection, or other parameters determined, for example, during establishment of one or more communication links with one or more other wireless devices). In some examples, the operation(s) at 1010 may be performed using the allowable energy density determiner 440 or 540 described with reference to FIG. 4 or 5.

At 1015, the method 1000 may include adjusting at least one RF transmission parameter of the wireless device based at least in part on the allowable energy density at the object. In some examples, adjusting the at least one RF transmission parameter may include altering a RF transmission duty cycle of the wireless device, altering a RF transmit power of the wireless device, altering a beamforming parameter of the wireless device (e.g., selecting at least one beamforming coefficient of the wireless device, a different beam pattern of a same antenna or antenna sub-array, a different antenna, or a different antenna sub-array, to direct RF energy away from the detected object while maintaining an acceptable RF communication link with one or more other wireless devices), or a combination thereof. In some examples, adjusting the RF transmit power may include reducing the RF transmit power or ceasing RF transmissions. In some examples, the at least one RF transmission parameter of the wireless device may be further adjusted based at least in part on a quality of a RF communication link between the wireless device and a second wireless device. In some examples, the method 1000 may further include determining a set of one or more RF transmission parameters for each of a plurality of antennas, antenna subarrays, RF transmission beams, or combinations thereof. In these latter examples, adjusting the at least one RF transmission parameter of the wireless device may include selecting one of the antennas, antenna subarrays, RF transmission beams, or combinations thereof. In some examples, the operation(s) at 1015 may be performed using the RF transmission parameter adjuster 445 or 545 described with reference to FIG. 4 or 5.

After the operation(s) at 1015, the method 1000 may optionally continue at 1020 or 1025. At 1020, the method 1000 may optionally include detecting a movement of the object to a new location within the energy mitigation area. Detecting the movement of the object to the new location within the energy mitigation area may include determining a new distance between the wireless device and the object. Upon detecting the movement of the object to the new location, the flow of the method 1000 may return to 1010. In some examples, the operation(s) at 1020 may be performed using the object detector 435 or 535 described with reference to FIG. 4 or 5.

At 1025, the method 1000 may optionally include detecting a movement of the object to outside the energy mitigation area. In some examples, the operation(s) at 1025 may be performed using the object detector 435 or 535 described with reference to FIG. 4 or 5.

At 1030, the method 1000 may optionally include ceasing to adjust the at least one RF transmission parameter of the wireless device, based at least in part on the allowable energy density at the object, after detecting the movement of the object to outside the energy mitigation area. In some examples, the operation(s) at 1030 may be performed using the RF transmission parameter adjuster 445 or 545 described with reference to FIG. 4 or 5.

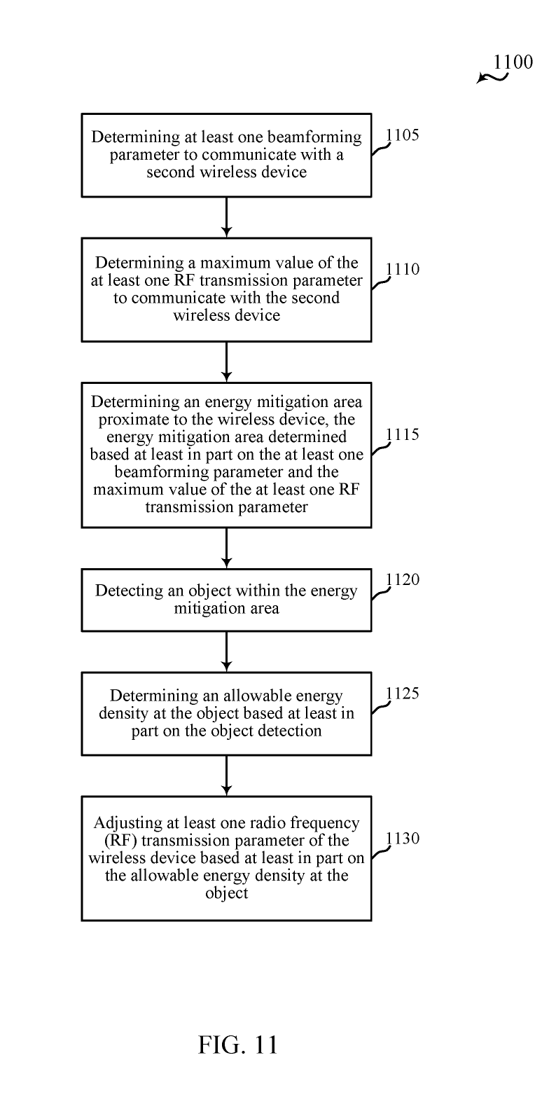

FIG. 11 is a flow chart illustrating an example of a method 1100 for wireless communication at a wireless device (e.g., a CPE, UE, or network access device), in accordance with one or more aspects of the present disclosure. For clarity, the method 1100 is described below with reference to aspects of one or more of the wireless devices described with reference to FIG. 1, 2, 3, 4, 5, 6, or 7, or aspects of one or more of the wireless communication managers described with reference to FIG. 4, 5, 6, or 7. In some examples, a wireless device may execute one or more sets of codes to control the functional elements of the wireless device to perform the functions described below. Additionally or alternatively, the wireless device may perform one or more of the functions described below using special-purpose hardware.

At 1105, the method 1100 may include determining at least one beamforming parameter (e.g., at least one of an optimal beamforming direction of a wireless device, a beamforming pattern of the wireless device, etc.) to communicate with a second wireless device. In some examples, the operation(s) at 1105 may be performed using the energy mitigation area determiner 550 described with reference to FIG. 5.

At 1110, the method 1100 may include determining a maximum value of at least one RF transmission parameter (e.g., at least one of a maximum RF transmission duty cycle of the wireless device, a maximum RF transmit power of the wireless device, etc.) to communicate with the second wireless device. In some examples, the operation(s) at 1110 may be performed using the energy mitigation area determiner 550 described with reference to FIG. 5.

At 1115, the method 1100 may include determining an energy mitigation area proximate to the wireless device, based at least in part on the at least one beamforming parameter and the maximum value of the at least one RF transmission parameter. In some examples, the energy mitigation area may be defined by a distance (e.g., a radius) and an arc or projection zone relative to the wireless device. In some examples, the operation(s) at 1115 may be performed using the energy mitigation area determiner 550 described with reference to FIG. 5.

At 1120, the method 1100 may include detecting an object within the energy mitigation area. Detecting the object within the energy mitigation area may include detecting that the object has at least one characteristic of a living organism. In some examples, detecting that the object has at least one characteristic of a living organism may include detecting a movement of the object, a capacitance of the object, a thermal energy of the object, or a combination thereof. In some examples, movement of the object may be detected based on infrared motion sensing, image processing, thermal imaging, or a combination thereof. Detecting the object within the energy mitigation area may also include determining a distance between the wireless device and the object. In some examples, the operation(s) at 1120 may be performed using the object detector 435 or 535 described with reference to FIG. 4 or 5.

At 1125, the method 1100 may include determining an allowable energy density at the object based at least in part on the object detection. In some examples, the allowable energy density may be determined based at least in part on the determined distance between the wireless device and the object. In some examples, the allowable energy density may be determined based at least in part on a directionality of RF energy emitted by the wireless device (e.g., as determined by beamforming parameters (e.g., beamforming coefficients), antenna selection, antenna sub-array selection, or other parameters determined, for example, during establishment of one or more communication links with one or more other wireless devices). In some examples, the operation(s) at 1125 may be performed using the allowable energy density determiner 440 or 540 described with reference to FIG. 4 or 5.

At 1130, the method 1100 may include adjusting at least one RF transmission parameter of the wireless device based at least in part on the allowable energy density at the object. In some examples, adjusting the at least one RF transmission parameter may include altering a RF transmission duty cycle of the wireless device, altering a RF transmit power of the wireless device, altering a beamforming parameter of the wireless device (e.g., selecting at least one beamforming coefficient of the wireless device, a different beam pattern of a same antenna or antenna sub-array, a different antenna, or a different antenna sub-array, to direct RF energy away from the detected object while maintaining an acceptable RF communication link with one or more other wireless devices), or a combination thereof. In some examples, adjusting the RF transmit power may include reducing the RF transmit power or ceasing RF transmissions. In some examples, the at least one RF transmission parameter of the wireless device may be further adjusted based at least in part on a quality of a RF communication link between the wireless device and a second wireless device. In some examples, the method 1100 may further include determining a set of one or more RF transmission parameters for each of a plurality of antennas, antenna subarrays, RF transmission beams, or combinations thereof. In these latter examples, adjusting the at least one RF transmission parameter of the wireless device may include selecting one of the antennas, antenna subarrays, RF transmission beams, or combinations thereof. In some examples, the operation(s) at 1130 may be performed using the RF transmission parameter adjuster 445 or 545 described with reference to FIG. 4 or 5.

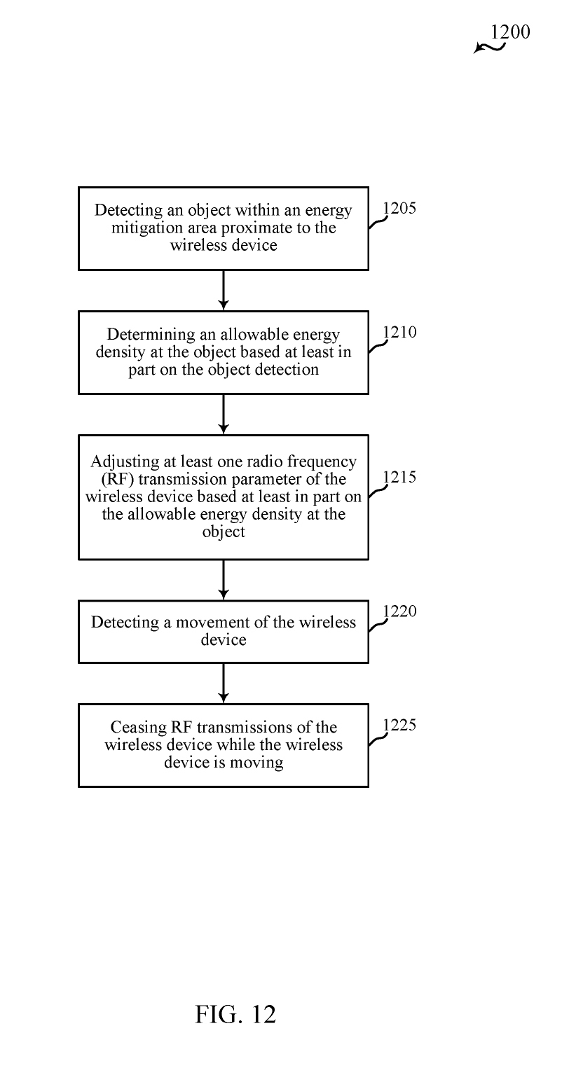

FIG. 12 is a flow chart illustrating an example of a method 1200 for wireless communication at a wireless device (e.g., a CPE, UE, or network access device), in accordance with one or more aspects of the present disclosure. For clarity, the method 1200 is described below with reference to aspects of one or more of the wireless devices described with reference to FIG. 1, 2, 3, 4, 5, 6, or 7, or aspects of one or more of the wireless communication managers described with reference to FIG. 4, 5, 6, or 7. In some examples, a wireless device may execute one or more sets of codes to control the functional elements of the wireless device to perform the functions described below. Additionally or alternatively, the wireless device may perform one or more of the functions described below using special-purpose hardware.

At 1205, the method 1200 may include detecting an object within an energy mitigation area proximate to the wireless device. Detecting the object within the energy mitigation area may include detecting that the object has at least one characteristic of a living organism. In some examples, detecting that the object has at least one characteristic of a living organism may include detecting a movement of the object, a capacitance of the object, a thermal energy of the object, or a combination thereof. In some examples, movement of the object may be detected based on infrared motion sensing, image processing, thermal imaging, or a combination thereof. Detecting the object within the energy mitigation area may also include determining a distance between the wireless device and the object. In some examples, the operation(s) at 1205 may be performed using the object detector 435 or 535 described with reference to FIG. 4 or 5.

At 1210, the method 1200 may include determining an allowable energy density at the object based at least in part on the object detection. In some examples, the allowable energy density may be determined based at least in part on the determined distance between the wireless device and the object. In some examples, the allowable energy density may be determined based at least in part on a directionality of RF energy emitted by the wireless device (e.g., as determined by beamforming parameters (e.g., beamforming coefficients), antenna selection, antenna sub-array selection, or other parameters determined, for example, during establishment of one or more communication links with one or more other wireless devices). In some examples, the operation(s) at 1210 may be performed using the allowable energy density determiner 440 or 540 described with reference to FIG. 4 or 5.

At 1215, the method 1200 may include adjusting at least one RF transmission parameter of the wireless device based at least in part on the allowable energy density at the object. In some examples, adjusting the at least one RF transmission parameter may include altering a RF transmission duty cycle of the wireless device, altering a RF transmit power of the wireless device, altering a beamforming parameter of the wireless device (e.g., selecting at least one beamforming coefficient of the wireless device, a different beam pattern of a same antenna or antenna sub-array, a different antenna, or a different antenna sub-array, to direct RF energy away from the detected object while maintaining an acceptable RF communication link with one or more other wireless devices), or a combination thereof. In some examples, adjusting the RF transmit power may include reducing the RF transmit power or ceasing RF transmissions. In some examples, the at least one RF transmission parameter of the wireless device may be further adjusted based at least in part on a quality of a RF communication link between the wireless device and a second wireless device. In some examples, the method 1200 may further include determining a set of one or more RF transmission parameters for each of a plurality of antennas, antenna subarrays, RF transmission beams, or combinations thereof. In these latter examples, adjusting the at least one RF transmission parameter of the wireless device may include selecting one of the antennas, antenna subarrays, RF transmission beams, or combinations thereof. In some examples, the operation(s) at 1215 may be performed using the RF transmission parameter adjuster 445 or 545 described with reference to FIG. 4 or 5.

At 1220, the method 1200 may include detecting a movement of the wireless device. The movement may be detected before, during, or after the operation(s) at 1205, 1210, or 1215. In some examples, the operation(s) at 1220 may be performed using the device movement detector 560 described with reference to FIG. 5.

At 1225, the method 1200 may include ceasing RF transmissions of the wireless device while the wireless device is moving. In some examples, object detection may also be ceased while the wireless device is moving. In some examples, RF transmissions (and in some examples, object detection) may be discontinued until the wireless device stops moving, or until RF transmission (and in some examples, object detection) is re-enabled by user interaction with the wireless device (e.g., through a reset button or other user interface, on or remote from the wireless device). In some examples, the operation(s) at 1225 may be performed using the RF transmission parameter adjuster 445 or 545 RF transmission parameter adjuster 445 or 545 described with reference to FIG. 4 or 5.

The methods 800, 900, 1000, 1100, and 1200 described with reference to FIGS. 8, 9, 10, 11, and 12 may provide for wireless communication. It should be noted that the methods 800, 900, 1000, 1100, and 1200 are example implementations of some of the techniques described in the present disclosure, and the operations of methods 800, 900, 1000, 1100, and 1200 may be rearranged, combined with other operations of the same or different method, or otherwise modified, such that other implementations are possible. Operations may also be added to the methods 800, 900, 1000, 1100, and 1200.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Techniques described herein may be used for various wireless communication systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A may be referred to as CDMA2000 1×, 1×, etc. IS-856 (TIA-856) may be referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-A are new releases of UMTS that use E-UTRA. UTRA, E-UTRA, UMTS, LTE, LTE-A, and GSM are described in documents from an organization named 3GPP. CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over an unlicensed or shared bandwidth. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent all of the examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Components implementing functions may also be physically located at various positions, including being distributed such that portions of functions are implemented at different physical locations. As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel techniques disclosed herein.

What is claimed is:

1. A method for wireless communication at a wireless device, comprising:
detecting an object within an energy mitigation area proximate to the wireless device;
determining an allowable energy density at the object based at least in part on the object detection; and
adjusting at least one radio frequency (RF) transmission parameter of the wireless device based at least in part on the allowable energy density at the object.

2. The method of claim 1, further comprising:
notifying a user of the wireless device upon detecting the object within the energy mitigation area.

3. The method of claim 2, further comprising:
receiving a reset indication from the user;
determining a distance between the wireless device and the object after detecting the object or receiving the reset indication; and
resetting the at least one RF transmission parameter of the wireless device based on the determined distance.

4. The method of claim 3, further comprising:
detecting, after resetting the at least one RF transmission parameter of the wireless device, a trigger condition comprising a movement of the wireless device or an enablement of RF transmission parameter adjustment at the wireless device; and
enabling adjustment of the at least one RF transmission parameter of the wireless device based at least in part on the trigger condition.

5. The method of claim 1, wherein detecting the object within the energy mitigation area comprises:
detecting that the object has at least one characteristic of a living organism.

6. The method of claim 5, wherein detecting that the object has at least one characteristic of a living organism comprises:
detecting a movement of the object, a capacitance of the object, a thermal energy of the object, or a combination thereof.

7. The method of claim 6, wherein the movement of the object is detected based at least in part on infrared motion sensing, image processing, thermal imaging, or a combination thereof.

8. The method of claim 5, further comprising:
detecting a movement of the object to a second location outside the energy mitigation area; and
resetting the at least one RF transmission parameter of the wireless device.

9. The method of claim 1, wherein detecting the object within the energy mitigation area comprises:
determining a distance between the wireless device and the object,
wherein the allowable energy density at the object is further determined based at least in part on the determined distance between the wireless device and the object.

10. The method of claim 1, wherein the allowable energy density is further determined based at least in part on a directionality of RF energy emitted by the wireless device.

11. The method of claim 1, wherein adjusting the at least one RF transmission parameter comprises: altering a RF transmission duty cycle of the wireless device, altering a RF transmit power of the wireless device, altering a beamforming parameter of the wireless device, or a combination thereof.

12. The method of claim 1, wherein adjusting the RF transmit power comprises reducing the RF transmit power or ceasing RF transmissions.

13. The method of claim 1, wherein the at least one RF transmission parameter of the wireless device is further adjusted based at least in part on a quality of a RF communication link between the wireless device and a second wireless device.

14. The method of claim 13, further comprising:
determining a set of one or more RF transmission parameters for each of a plurality of antennas, antenna subarrays, RF transmission beams, or combinations thereof;
wherein adjusting the at least one RF transmission parameter of the wireless device comprises selecting one of the antennas, antenna subarrays, RF transmission beams, or combinations thereof.

15. The method of claim 1, further comprising:
determining at least one beamforming parameter to communicate with a second wireless device;
determining a maximum value of the at least one RF transmission parameter to communicate with the second wireless device; and
identifying the energy mitigation area based at least in part on the at least one beamforming parameter and the maximum value of the at least one RF transmission parameter.

16. The method of claim 1, further comprising:
detecting a movement of the wireless device; and
ceasing RF transmissions of the wireless device while the wireless device is moving.

17. An apparatus for wireless communication, comprising:
means for detecting an object within an energy mitigation area proximate to the apparatus;
means for determining an allowable energy density at the object based at least in part on the object detection; and
means for adjusting at least one radio frequency (RF) transmission parameter of the apparatus based at least in part on the allowable energy density at the object.

18. The apparatus of claim 17, further comprising:
means for notifying a user of the apparatus upon detecting the object within the energy mitigation area.

19. The apparatus of claim 18, further comprising:
means for receiving a reset indication from the user;
means for determining a distance between the apparatus and the object after detecting the object or receiving the reset indication; and
means for resetting the at least one RF transmission parameter of the apparatus based on the determined distance.

20. The apparatus of claim 19, further comprising:
means for detecting a trigger condition comprising a movement of the apparatus or an enablement of RF transmission parameter adjustment at the apparatus; and
means for enabling adjustment of the at least one RF transmission parameter of the apparatus based at least in part on the trigger condition.

21. The apparatus of claim 17, wherein the means for detecting the object within the energy mitigation area comprises:
means for detecting a movement of the object, a capacitance of the object, a thermal energy of the object, or a combination thereof.

22. The apparatus of claim 21, further comprising:
means for resetting the at least one RF transmission parameter of the apparatus based at least in part on detecting the movement of the object.

23. The apparatus of claim 17, wherein the means for detecting the object within the energy mitigation area comprises:
means for determining a distance between the apparatus and the object,
wherein the allowable energy density at the object is further determined based at least in part on the determined distance between the apparatus and the object.

24. The apparatus of claim 17, wherein the means for determining the allowable energy density further determines the allowable energy density based at least in part on a directionality of RF energy emitted by the apparatus.

25. The apparatus of claim 17, wherein the means for adjusting the at least one RF transmission parameter comprises means for altering a RF transmission duty cycle of the apparatus or means for altering a RF transmit power of the apparatus.

26. The apparatus of claim 17, wherein the at least one RF transmission parameter of the apparatus is further adjusted based at least in part on a quality of a RF communication link between the apparatus and a second apparatus.

27. The apparatus of claim 26, further comprising:
means for determining a set of one or more RF transmission parameters for each of a plurality of antennas, antenna subarrays, RF transmission beams, or combinations thereof.
wherein the means for adjusting the at least one RF transmission parameter of the apparatus comprises means for selecting one of the antennas, antenna subarrays, RF transmission beams, or combinations thereof.

28. The apparatus of claim 17, further comprising:
means for determining at least one beamforming parameter to communicate with a second apparatus;
means for determining a maximum value of the at least one RF transmission parameter to communicate with the second apparatus; and
means for identifying the energy mitigation area based at least in part on the at least one beamforming parameter and the maximum value of the at least one RF transmission parameter.

29. The apparatus of claim 17, further comprising:
means for detecting a movement of the apparatus; and
means for ceasing RF transmissions of the apparatus while the apparatus is moving.

30. An apparatus for wireless communication, comprising:
a processor;
memory in electronic communication with the processor; and
instructions stored in the memory, wherein the instructions are executable by the processor to:
detect an object within an energy mitigation area proximate to the apparatus;
determine an allowable energy density at the object based at least in part on the object detection; and
adjust at least one radio frequency (RF) transmission parameter of the apparatus based at least in part on the allowable energy density at the object.

31. The apparatus of claim 30, wherein the instructions are executable by the processor to:
notify a user of the apparatus upon detecting the object within the energy mitigation area.

32. The apparatus of claim 31, wherein the instructions are executable by the processor to:
receive a reset indication from the user;
determine a distance between the apparatus and the object after detecting the object or receiving the reset indication; and
reset the at least one RF transmission parameter of the apparatus based on the determined distance.

33. The apparatus of claim 32, wherein the instructions are executable by the processor to:
detect, after resetting the at least one RF transmission parameter of the apparatus, a trigger condition comprising a movement of the apparatus or an enablement of RF transmission parameter adjustment at the apparatus; and
enable adjustment of the at least one RF transmission parameter of the apparatus based on the trigger condition.

34. The apparatus of claim 30, wherein the instructions executable by the processor to detect the object within the energy mitigation area comprise instructions executable by the processor to:
detect a movement of the object, a capacitance of the object, a thermal energy of the object, or a combination thereof.

35. The apparatus of claim 34, wherein the instructions are executable by the processor to:
reset the at least one RF transmission parameter of the apparatus based at least in part on detecting the movement of the object.

36. The apparatus of claim 30, wherein the instructions executable by the processor to detect the object within the energy mitigation area comprise instructions executable by the processor to:
determine a distance between the apparatus and the object,
wherein the allowable energy density at the object is further determined based at least in part on the determined distance between the apparatus and the object.

37. The apparatus of claim 30, wherein the instructions executable by the processor to determine the allowable energy density further determine the allowable energy density based at least in part on a directionality of RF energy emitted by the apparatus.

38. The apparatus of claim 30, wherein the instructions executable by the processor to adjust the at least one RF transmission parameter comprise instructions executable by the processor to alter a RF transmission duty cycle of the apparatus, alter a RF transmit power of the apparatus, or a combination thereof.

39. The apparatus of claim 30, wherein the instructions executable by the processor to adjust the RF transmit power comprise instructions executable by the processor to reduce the RF transmit power or cease RF transmissions.

40. The apparatus of claim 30, wherein the at least one RF transmission parameter of the apparatus is further adjusted based at least in part on a quality of a RF communication link between the apparatus and a second apparatus.

41. The apparatus of claim 40, wherein the instructions are executable by the processor to:
determine a set of one or more RF transmission parameters for each of a plurality of antennas, antenna subarrays, RF transmission beams, or combinations thereof;
wherein the instructions executable by the processor to adjust the at least one RF transmission parameter of the apparatus comprises instructions executable by the processor to select one of the antennas, antenna subarrays, RF transmission beams, or combinations thereof.

42. The apparatus of claim 30, wherein the instructions are executable by the processor to:
determine at least one beamforming parameter to communicate with a second apparatus;
determine a maximum value of the at least one RF transmission parameter to communicate with the second apparatus; and
identify the energy mitigation area based at least in part on the at least one beamforming parameter and the maximum value of the at least one RF transmission parameter.

43. The apparatus of claim 30, wherein the instructions are executable by the processor to:
detect a movement of the apparatus; and
cease RF transmissions of the apparatus while the apparatus is moving.

44. A non-transitory computer-readable medium storing code for wireless communication at a wireless device, the code comprising instructions executable to:
detect an object within an energy mitigation area proximate to the wireless device;
determine an allowable energy density at the object based at least in part on the object detection; and
adjust at least one radio frequency (RF) transmission parameter of the wireless device based at least in part on the allowable energy density at the object.
